(19) United States
(12) Patent Application Publication
(10) Pub. No.: US 2025/0385887 A1
(43) Pub. Date: Dec. 18, 2025

(54) STATIC RESOURCE IDENTIFIERS IN PRE-FABRICATED SCALABLE FOOTPRINT DATA CENTERS

(71) Applicant: Oracle International Corporation, Redwood Shores, CA (US)

(72) Inventors: Scott Allan Deboy, Portland, OR (US); Michel Belleau, L'Ange-Gardien (CA)

(73) Assignee: Oracle International Corporation, Redwood Shores, CA (US)

(21) Appl. No.: 19/238,247

(22) Filed: Jun. 13, 2025

Related U.S. Application Data
(60) Provisional application No. 63/660,377, filed on Jun. 14, 2024.
(60) Provisional application No. 63/691,152, filed on Sep. 5, 2024.

(51) Int. Cl. H04L 61/00

(52) U.S. Cl. CPC H04L 61/00

(57) ABSTRACT

Techniques are disclosed for static identifiers for software resources within the scalable footprint data center at various stages during the prefab process. A computing node in a region network and during a region build process can receive a static identifier for a software resource within the region network. The static identifier can include a static string corresponding to a region identifier for the region network. A service executing in the region network and after the region network is configured in a scalable footprint data center can receive a request that includes the static identifier. The service can determine whether the static identifier includes the static string. Based at least in part on a determination that the static identifier includes the static string, the service can obtain the region identifier for the region network from a datastore in the scalable footprint data center.

This application claims priority to and the benefit of the following applications, the entire contents of which are hereby incorporated by reference in their entirety for all purposes:
1. U.S. Provisional Patent Application 63/660,377, filed on Jun. 14, 2024, entitled “DRCC ARCHITECTURE UPDATE”; and
2. U.S. Provisional Patent Application 63/691,152, filed on Sep. 5, 2024, entitled “DEVICE IMAGING FOR BUILDING PRE-FABRICATED REDUCED FOOTPRINT DATA CENTERS.”

### BACKGROUND

Cloud service providers (CSPs) can offer computing infrastructure for customers using resources in several data centers. As cloud computing demand increases, CSPs can improve the availability of cloud resources by scaling the data centers. However, scaling can result in large data center footprints with a significant number of computing devices requiring a commensurate amount of resources to operate as well as reserving significant computing resources for the effective management of the cloud resources themselves.

### BRIEF SUMMARY

Embodiments described herein relate to cloud computing networks. More particularly, the present disclosure describes architectures, infrastructure, and related techniques for configuring the computing devices of a scalable footprint data center at a Prefab factory. A typical Cloud Service Provider (CSP) may provide cloud services to one or more customers which may have one or more tenancies. Each customer and/or tenancy may have the ability to customize and configure the infrastructure provisioned to support their allocated cloud resources. To manage the infrastructure provisioning for multiple customers, the CSP may reserve computing resources within a data center to provide certain “core” services to both customers and to other services operated by the CSP. For example, services like compute, networking, block storage, object storage, identity and access management, and key management and secrets services are implemented within a “service enclave” of the data center. The service enclave may connect via a substrate network of computing devices (virtual machines and/or bare metal instances) hosted within the data center. The substrate network may be a part of the “underlay network” of the data center, which includes the physical network connecting bare metal devices, smart network interface cards (SmartNICs) of the computing devices, and networking infrastructure like top-of-rack switches. By contrast, CSP customers have infrastructure provisioned in an “overlay network” comprising one or more virtual cloud networks (VCNs) of virtualized environments to provide resources for the customer (e.g., compute, storage, etc.).

The service enclave exists on dedicated hardware within the data center. Because of this, the services hosted within the service enclave are difficult to scale. Whereas additional racks and servers can be implemented within the data center to expand the resources available to CSP customers, the dedicated computing resources for the service enclave are typically of a fixed size that depends on the largest predicted size of the data center. Expanding the service enclave can require a complicated addition of computing resources that may impact the availability of the core services to customers. Additionally, unused resources within the service enclave (e.g., if the service enclave is sized too large for the customer demand from the data center) cannot be easily made available to the customers, since the service enclave does not typically allow network access from the customer overlay network.

Even as the demand for cloud services grows, CSPs may want to deploy data centers to meet that demand that initially have the smallest physical footprint possible. Such a footprint can improve the ease of both deploying the physical components and configuring the initial infrastructure while still allowing the data center to scale to meet customer demand. In the scalable footprint, rather than dedicate a portion of the computing hardware to providing the service enclave, the “core services” that are hosted in the service enclave can instead be implemented in the overlay network. By doing so, the core services can be scaled as the data center footprint expands. The computing devices used to construct the scalable footprint data center can be homogenized, improving the initial configuration and easing the expansion of the footprint when additional, homogeneous devices are added. In addition, by eliminating the substrate network, flexible overlay network shapes are made available for both CSP core services and customers.

A prefab factory may be a facility dedicated to configuring computing devices, networking devices, and other physical resources of a data center environment for delivery to a destination site (e.g., a customer facility, etc.). Operations for building a data center environment can include bootstrapping (e.g., provisioning and/or deploying) resources (e.g., infrastructure components, artifacts, etc.) for any suitable number of services available from the data center environment when delivered to the destination. Once the physical resources have been configured at the prefab factory, they may be shipped to the destination site, installed at the destination data center, and have final configurations and other software resources deployed to the physical resources. A prefab factory can also be used to configure the computing devices of a scalable footprint data center. Because a scalable footprint data center can include component configurations that are not typically present in conventional data center environments, the techniques for building a scalable footprint data center in a prefab factory can be tailored to address the converged computing architecture of the scalable footprint data center components.

Embodiments described herein relate to methods, systems, and computer-readable media for static identifiers for software resources within the scalable footprint data center at various stages during the prefab process. A method for providing static identifiers can include receiving, at a computing node in a region network and during a region build process, a static identifier for a software resource within the region network. The static identifier can include a static string corresponding to a region identifier for the region network. The method can also include receiving, at a service executing in the region network and after the region network is configured in a scalable footprint data center, a request comprising the static identifier. The service can determine whether the static identifier includes the static string. Based at least in part on a determination that the static identifier comprises the static string, the service can obtain from a datastore the region identifier for the region network in the scalable footprint data center.

Another embodiment is directed to a computing system including one or more processors and one or more memories storing computer-executable instructions that, when executed by the one or more processors, cause the computing system to perform the method described above.

Yet another embodiment is directed to a non-transitory computer-readable medium storing computer-executable instructions that, when executed by one or more processors of a distributed computing system, cause the computing system to perform the method described above. In addition, embodiments may be implemented by using a computer program product, comprising computer program/instructions which, when executed by a processor, cause the processor to perform any of the methods described in the disclosure.

### BRIEF DESCRIPTION OF DRAWINGS

FIG. 1 is a block diagram illustrating the consolidation of computing resources in a scalable footprint data center, according to some embodiments.

FIG. 2 is a block diagram showing the configuration of a hyperconverged server rack for use in a scalable footprint data center, according to some embodiments.

FIG. 3 is a block diagram illustrating an example architecture of a scalable footprint data center in small, medium, and large footprints, according to some embodiments.

FIG. 4 is a diagram illustrating an example scalable footprint data center, according to some embodiments.

FIG. 5 is a block diagram illustrating an example physical networking architecture for a scalable footprint data center, according to some embodiments.

FIG. 6 is a block diagram illustrating an example architecture for networking in a scalable footprint data center, according to some embodiments.

FIG. 7 is a block diagram illustrating example applications that can be provided from a scalable footprint data center, according to some embodiments.

FIG. 8 is a block diagram illustrating a BIOS server architecture in a scalable footprint data center, according to some embodiments.

FIG. 9 is a block diagram illustrating an example architecture of a prefab factory in which a region network of a scalable footprint data center can be configured, according to some embodiments.

FIG. 10 is a block diagram illustrating an example process for configuring a region network of a scalable footprint data center, according to some embodiments.

FIG. 11 is a block diagram illustrating an example architecture for imaging server devices of a scalable footprint data center, according to some embodiments.

FIG. 12 is a block diagram illustrating an example architecture for reconfiguring services in a scalable footprint data center, according to some embodiments.

FIG. 13 is a block diagram illustrating an example process of a reconfiguration service orchestrating a reconfiguration process with a service in a scalable footprint data center, according to some embodiments.

FIG. 14A is a block diagram illustrating an identities service configured to provide static identifiers to resources in during a region build operation, according to some embodiments.

FIG. 14B is a block diagram illustrating the identities service providing identifiers to additional software resources in a scalable footprint data center environment after configuration at a destination data center facility, according to some embodiments.

FIG. 15 is a flow diagram of an example process for imaging server devices of a scalable footprint data center, according to some embodiments.

FIG. 16 is a flow diagram of an example process for reconfiguring a service in a scalable footprint data center, according to some embodiments.

FIG. 17 is a flow diagram of an example process for providing static resource identifiers in scalable footprint data center, according to some embodiments.

FIG. 18 is a block diagram of an example process for deploying cumulative upgrades to services of a scalable footprint data center, according to some embodiments.

FIG. 19 is a block diagram illustrating an example computer system, according to at least one embodiment.

### DETAILED DESCRIPTION

The adoption of cloud services has seen a rapid uptick in recent times. Various types of cloud services are now provided by various different cloud service providers (CSPs). The term cloud service is generally used to refer to a service or functionality that is made available by a CSP to users or customers on demand (e.g., via a subscription model) using systems and infrastructure (cloud infrastructure) provided by the CSP. Typically, the servers and systems that make up the CSP's infrastructure and which is used to provide a cloud service to a customer are separate from the customer's own on-premises servers and systems. Customers can thus avail themselves of cloud services provided by the CSP without having to purchase separate hardware and software resources for the services. Cloud services are designed to provide a subscribing customer easy, scalable, and on-demand access to applications and computing resources without the customer having to invest in procuring the infrastructure that is used for providing the services or functions. Various different types or models of cloud services may be offered such as Software-as-a-Service (SaaS), Platform-as-a-Service (PaaS), Infrastructure-as-a-Service (IaaS), and others. A customer can subscribe to one or more cloud services provided by a CSP. The customer can be any entity such as an individual, an organization, an enterprise, and the like.

As indicated above, a CSP is responsible for providing the infrastructure and resources that are used for providing cloud services to subscribing customers. The resources provided by the CSP can include both hardware and software resources. These resources can include, for example, compute resources (e.g., virtual machines, containers, applications, processors), memory resources (e.g., databases, data stores), networking resources (e.g., routers, host machines, load balancers), identity, and other resources. In certain implementations, the resources provided by a CSP for providing a set of cloud services CSP are organized into data centers. A data center may be configured to provide a particular set of cloud services. The CSP is responsible for equipping the data center with infrastructure and resources that are used to provide that particular set of cloud services. A CSP may build one or more data centers.

A scalable footprint data center can have a new architecture for a region in which the initial network footprint is as small as feasible (e.g., six racks, four racks, and possibly even a single rack of server devices) while still providing core cloud services and scalability for customer demands. In particular, a scalable footprint data center may not segregate resources used for cloud services of the CSP from the resources available for the customer's applications. Instead, the scalable footprint data center can place core CSP services like Block Storage, Object Storage, Identity, Key Management, and Secrets, which operate in a Substrate Network in a conventional data center environment, into an Overlay network. This means that a scalable footprint data center may not have dedicated hosts for the Substrate Network. Such an architectural change can require particular solutions for connectivity between CSP services that now operate in the Overlay network. In addition, a small portion of fundamental boot services may be provided to ensure initial route configuration for the services in the Overlay during startup and/or recovery. However, the convergence of both CSP infrastructure resources and customer infrastructure resources can allow the scalable footprint data center to maximize the allocation of resources for both cloud services and customer applications while enabling efficient expansion and scaling of the data center as customer needs grow.

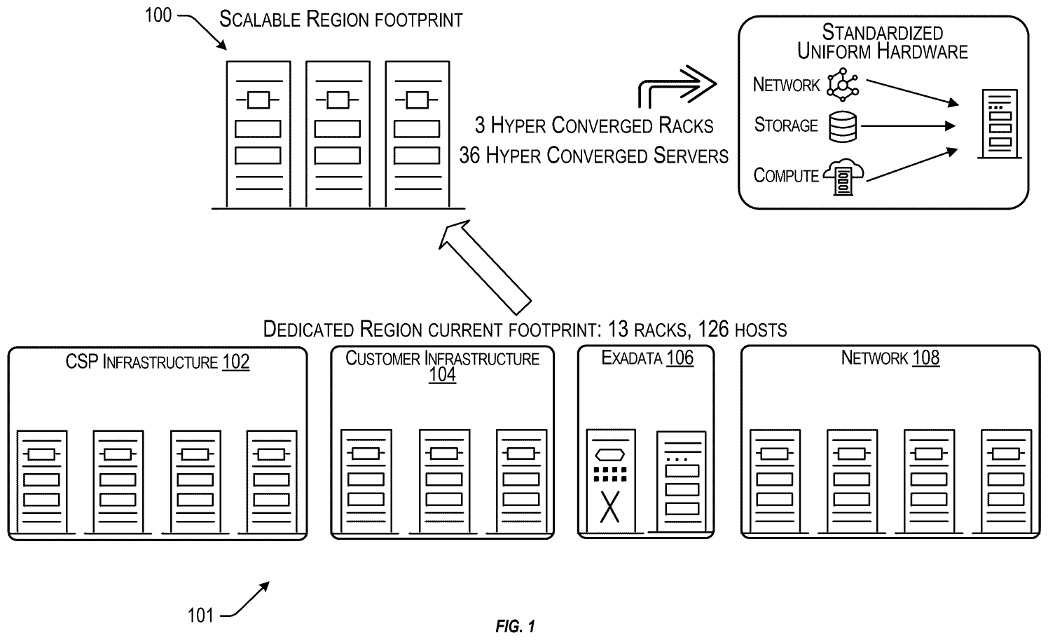

FIG. 1 is a block diagram illustrating the consolidation of computing resources in a scalable footprint data center 100, according to some embodiments. The scalable footprint data center 100 can be a data center forming a region or “region network.” A “region” is a logical abstraction of computing, networking, and storage resources of one or more data centers providing a cloud environment corresponding to a particular geographic region. FIG. 1 also shows a conventional data center 101 for providing cloud resources to customers of the region.

In a conventional data center 101, the plurality of server racks can each include multiple server devices as well as networking equipment (e.g., top of rack switches) and power supply and distribution equipment. The conventional data center 101 can have a standard footprint of 13 server racks as shown, with 126 bare metal host server devices, although additional server racks are possible in larger data centers.

To provide networking isolation between customer data and CSP data for CSP services executing in the conventional data center 101, a portion of the server racks can be reserved as a service enclave, so that the computing devices on those server racks can host and provide CSP services within the conventional data center 101 without also hosting customer data. As shown in FIG. 1, CSP infrastructure 102 and customer infrastructure 104 are separate, reserving a certain number of server racks (e.g., 4 racks) for CSP services and a certain number of server racks (e.g., 3 racks) for customer applications and data. The CSP infrastructure 102 can constitute the service enclave, while customer infrastructure 104 can form a portion of the customer enclave.

The isolation between the service enclave and the customer enclave can be enforced by software-defined perimeters that define edge devices and/or software within the enclave as distinguished from hardware/software elements outside of the enclave. Access into and out of each enclave may be controlled, monitored, and/or policy driven. For example, access to the service enclave may be based on authorization, limited to authorized clients of the CSP. Such access may be based on one or more credentials provided to the enclave.

The conventional data center 101 can also include Exadata database racks 106 and networking racks 108. The database racks 106 can include computing devices and storage devices that provide storage and management for databases, data stores, object storage, and similar data persistence techniques within the conventional data center 101. The networking racks 108 can include networking devices that provide connectivity to the computing devices within conventional data center 101 and to other networks (e.g., customer networks, the internet, etc.).

Unlike the conventional data center 101, in which particular server racks are reserved as CSP infrastructure 102 and customer infrastructure 104, the scalable footprint data center 100 can consolidate the network, storage, and compute resources that are separate in the conventional data center 101 into converged server racks. To meet the desired “as small as feasible” footprint, a new scalable footprint rack design can be used, including next-generation server devices referred to as “hyperconverged servers” that are configured to have the highest possible resource density and security capabilities for enabling substrate services in the overlay network. For example, a “hyperconverged” server device can include 2× 192 core processors, 24× 256 GB DDR5 RAM modules, 14× 15.6 TB NVMe drives, a smart network interface card (SmartNIC), and a trusted platform module (TPM). The server racks that include hyperconverged server devices can then be referred to as “hyperconverged racks” or “scalable footprint racks.” The scalable footprint racks can have a standardized shape. For example, a “low density” configuration of a hyperconverged server rack can include six hyperconverged servers, while a “high density” configuration can include 12 hyperconverged servers. The new server architecture can allow for deployment of a scalable footprint data center having only a single rack hosting the core CSP services while still providing cloud resources to the customer. The initial footprint can then be scaled out as customer needs increase. In a typical configuration, a scalable footprint data center 100 can include three hyperconverged server racks for a total of 36 hyperconverged server devices providing all of the network, storage, and compute capabilities of a region network.

The following definitions are useful for portions of a scalable footprint data center built by a CSP:

Underlay network—The physical network that sits below the overlay network and virtual cloud networks (VCNs) therein. In a conventional data center 101, the existing Substrate network hosting the CSP services is a portion of the underlay network. ILOM ports, management and SmartNIC substrate addresses are also part of the underlay network.

Overlay network—The network environment that is available for use by executing services and applications, including virtualization environments, that provide the functionality of the data center to both customers and the CSP. The overlay network can include VCN(s), virtualization environments, and networking connections from these VCNs in the scalable footprint data center to other cloud computing services of the CSP (e.g., services provided in other data center environments).

Substrate network—A portion of the underlay network that contains host devices (e.g., bare metal computing devices and/or VMs) running only Substrate services. In existing environments these host devices may not have SmartNICs. The host devices may be managed by service teams responsible for one or more of the substrate services.

Substrate Services—The list of services that run in the Substrate network of a conventional data center 101. While most of these run in a service enclave (e.g., CSP infrastructure 102), some substrate service live outside of the service enclave. The substrate services have a mix of services that may communicate to the underlay network (e.g. Network Monitoring) and services that are hosted in the service enclave (e.g. Object Storage).

SmartNIC—A computing component that combines a network interface card with additional functionality for network virtualization to create layers of network abstraction that can be run on top of the physical networking components (e.g., the underlay network). The SmartNIC can include processors and memory that can perform computing operations to provide the additional functionality. In the conventional data center 101, host devices of the CSP infrastructure 102 do not include a SmartNIC, while host devices of the customer infrastructure 104 do include a SmartNIC. In the scalable footprint data center 100, all hyperconverged server devices will include a SmartNIC.

Integrated lights out managers (ILOMs)—An ILOM can be a processor or processing platform integrated with bare metal hosts in a data center that can provide functionality for managing and monitoring the hosts remotely in cases where the general functionality of the host may be impaired (e.g., fault occurrence).

Trusted Platform Module—a microcontroller or other processor (or multiple processors) along with storage for performing cryptographical operations like hashing, encryption/decryption, key and key pair generation, and key storage. The TPM may generally conform to a standard characterizing such devices, for example, ISO/IEC 11889. Each server device and BIOS device in a scalable footprint data center can include a TPM.

BIOS Device—A computing device or a plurality of computing devices on a server rack in the scalable footprint data center. The BIOS device may be designed to enable independent and resilient operations during various boot scenarios and network disruptions. The BIOS device may be configured to facilitate the initial boot processes for the scalable footprint data center, provide essential services during recovery, and ensure the region's stability, especially in power-constrained environments. The BIOS device hosts a range of functions, all of which can allow the autonomous operation of the region. For example, these functions can include DNS resolution, NTP synchronization, DHCP/ZTP configuration, and various security and provisioning services. By offering these capabilities, the BIOS device ensures that the rack can bootstrap itself, recover from power or network-related events, and maintain essential connectivity and management functions without relying on external resources. In various embodiments, the BIOS device can have similar hardware specifications (e.g., number of processors, amount of memory, amount of attached storage devices) as other server devices on the rack. In some instances, the functionality of the BIOS device may be provided by a computer-readable media that stores instructions that can be executed by a computer to implement the BIOS services. The BIOS device may not have a SmartNIC while other bare metal host devices in the rack do have a SmartNIC.

The following definitions are useful in the context of building region data centers in a prefab factory environment.

A “region” is a logical abstraction corresponding to a collection of computing, storage, and networking resources associated with a geographical location. A region can include any suitable number of one or more execution targets. A region may be associated with one or more data centers. A “prefab region” describes a region built in a prefab factory environment prior to delivery to the corresponding geographical location. A “Butterfly region” refers to a region for a scalable footprint data center, in which the initial computing components like server racks occupy. In some embodiments, an execution target could correspond to the destination data center as opposed to the prefab factory data center.

An “execution target” refers to a smallest unit of change for executing a release. A “release” refers to a representation of an intent to orchestrate a specific change to a service (e.g., deploy version 8, “add an internal DNS record,” etc.). For most services, an execution target represents an “instance” of a service or an instance of change to be applied to a service. A single service can be bootstrapped to each of one or more execution targets. An execution target may be associated with a set of devices (e.g., a data center).

“Bootstrapping” a single service is intended to refer to the collective tasks associated with provisioning and deployment of any suitable number of resources (e.g., infrastructure components, artifacts, etc.) corresponding to a single service. Bootstrapping a region is intended to refer to the collective of tasks associated with each of the bootstrap of each of the services intended to be in the region.

A “service” refers to functionality provided by a set of resources, typically in the form of an API that customers can invoke to achieve some useful outcome. A set of resources for a service includes any suitable combination of infrastructure, platform, or software (e.g., an application) hosted by a cloud provider that can be configured to provide the functionality of a service. A service can be made available to users through the Internet.

An “artifact” refers to code being deployed to an infrastructure component or a Kubernetes engine cluster, this may include software (e.g., an application), configuration information (e.g., a configuration file), credentials, for an infrastructure component, or the like.

IaaS provisioning (or “provisioning”) refers to acquiring computers or virtual hosts for use, and even installing needed libraries or services on them. The phrase “provisioning a device” refers to evolving a device to a state in which it can be utilized by an end-user for their specific use. A device that has undergone the provisioning process may be referred to as a “provisioned device.” Preparing the provisioned device (installing libraries and daemons) may be part of provisioning; this preparation is different from deploying new applications or new versions of an application onto the prepared device. In most cases, deployment does not include provisioning, and the provisioning may need to be performed first. Once prepared, the device may be referred to as “an infrastructure component.”

IaaS deployment (or “deployment”) refers to the process of providing and/or installing a new application, or a new version of an application, onto a provisioned infrastructure component. Once the infrastructure component has been provisioned (e.g., acquired, assigned, prepared, etc.), additional software may be deployed (e.g., provided to and installed on the infrastructure component). The infrastructure component can be referred to as a “resource” or “software resource” after provisioning and deployment has concluded. Examples of resources may include, but are not limited to, virtual machines, databases, object storage, block storage, load balancers, and the like.

A “virtual bootstrap environment” (ViBE) refers to a virtual cloud network that is provisioned in the overlay network of an existing region (e.g., a “host region”). Once provisioned, a ViBE is connected to a new region using a communication channel (e.g., an IPSec Tunnel VPN). Certain essential core services (or “seed” services) like a deployment orchestrator, a public key infrastructure (PKI) service, a dynamic host configuration protocol service (DHCP), a domain name service (DNS), and the like can be provisioned in a ViBE. These services can provide the capabilities required to bring the hardware online, establish a chain of trust to the new region, and deploy the remaining services in the new region. Utilizing the virtual bootstrap environment can prevent circular dependencies between bootstrapping resources by utilizing resources of the host region. These services can be staged and tested in the ViBE prior to the prefab region (e.g., the target region) being available.

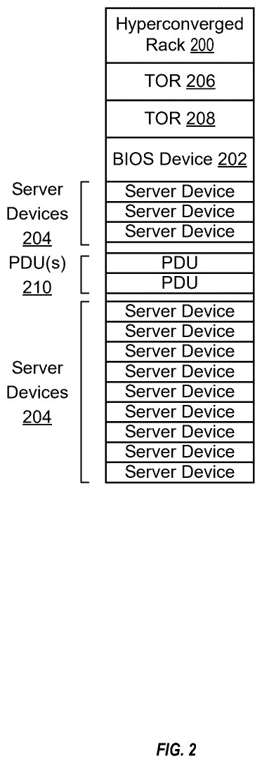

FIG. 2 is a block diagram showing the configuration of a hyperconverged server rack 200 for use in a scalable footprint data center, according to some embodiments. In some embodiments, the hyperconverged server rack 200 can be a standard 42U size server rack. As shown in FIG. 2, hyperconverged server rack 200 can include two TORs, TOR 206 and TOR 208. The hyperconverged server rack 200 can also include BIOS device 202, which can be a server device used for initialization operations in the scalable footprint data center and two power distribution units (PDUs) 210.

The hyperconverged server rack 200 can include server devices 204. As depicted in FIG. 2, the hyperconverged server rack 200 can be a high-density configuration including 12 server device 204. In some embodiments, the hyperconverged server rack 200 can be a low-density configuration with six server devices. The server devices 204 can be hyperconverged server devices as described above, including two 192 core processors, 24 256 GB DDR5 RAM modules (for 6 TB total memory), a SmartNIC supporting two 100G uplinks, a host NIC also supporting two 100G uplinks, two 960 GB m.2 NVMe boot drives, 14 15.6 TB NVMe storage drives, and a TPM. However, one skilled in the art would appreciate that server devices having even greater computing resource density are possible in the server racks described herein. The PDUs 210 for hyperconverged server rack 200 may be configured to provide sufficient power to the server devices 204 on the hyperconverged server rack 200.

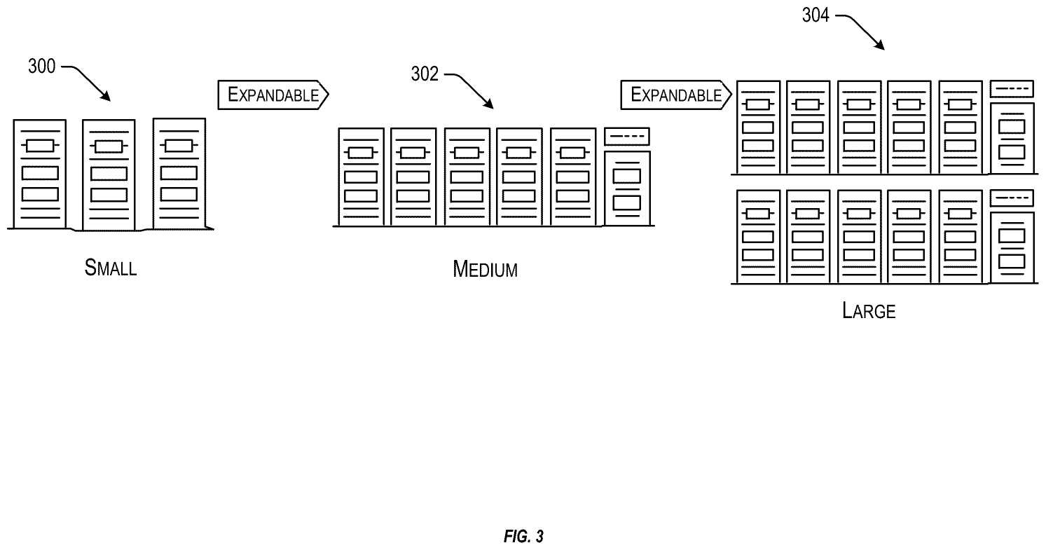

FIG. 3 is a block diagram illustrating an example architecture of a scalable footprint data center in small, medium, and large footprints, according to some embodiments. An initial deployment of infrastructure components for a scalable footprint data center can include three server racks (e.g., three hyperconverged server racks 200 of FIG. 2). From there, the scalable footprint data center can be expanded to provide additional resources for customer applications (and CSP services) in the region. Each of the three footprints for a scalable footprint data center are described below.

Small Footprint 300—A small footprint 300 can begin with three scalable footprint racks. Additional scalable footprint racks can be added to the small footprint 300. Depending on the configuration of the rack (e.g., high-density or low-density), up to six high density scalable footprint racks or up to 12 low density scalable footprint racks can be included in the small footprint 300. Each additional scalable footprint rack can be connected to the existing footprint in a ring network using the TOR switches on each rack. Because the service control planes are functional in the overlay of the initial scalable footprint rack, the additional racks can be adapted to provide additional data plane resources for those services. Each scalable footprint rack can support connections to the customer's network. In some embodiments, the small footprint can include as few as one scalable footprint rack.

Medium Footprint 302—From a small footprint 300, the scalable footprint data center can have additional racks added. To support racks beyond the upper capacity of the small footprint 300, a new networking rack can be connected to the existing scalable footprint data center and then connected to the additional racks. In some embodiments, the additional racks can be conventional racks rather than scalable footprint racks. For example, the additional racks can be conventional racks that use server devices other than the hyperconverged server devices described herein. The ring network of the small footprint 300 can be preserved even with the connection to the networking rack. In some embodiments, the networking rack can support connections to 64 total racks (inclusive of the scalable footprint racks) and can provide the connection to the customer's network. Example specifications for the networking rack include two chasses that each have 4 LCs each with 24×400G ports for a total of 384×100G links, 8×100G connections to each server rack (up to 64 racks), up to 128×100G towards the customer network, and up to 128×100G available for future expansion.

Large Footprint 304—From the medium footprint 302, the scalable footprint data center can have additional capacity beyond 64 total racks added. The large footprint 304 may require adding an optical gate rack for connecting additional racks beyond the 64 rack limit. The additional racks of the large footprint 304 can include racks (e.g., QFab) supporting Exadata (e.g., Exadata 106 of FIG. 1) or other high-capacity, high-throughput data service. Within the large footprint 304, the original scalable footprint racks of the small footprint 300 can continue to provide the core services of the CSP.

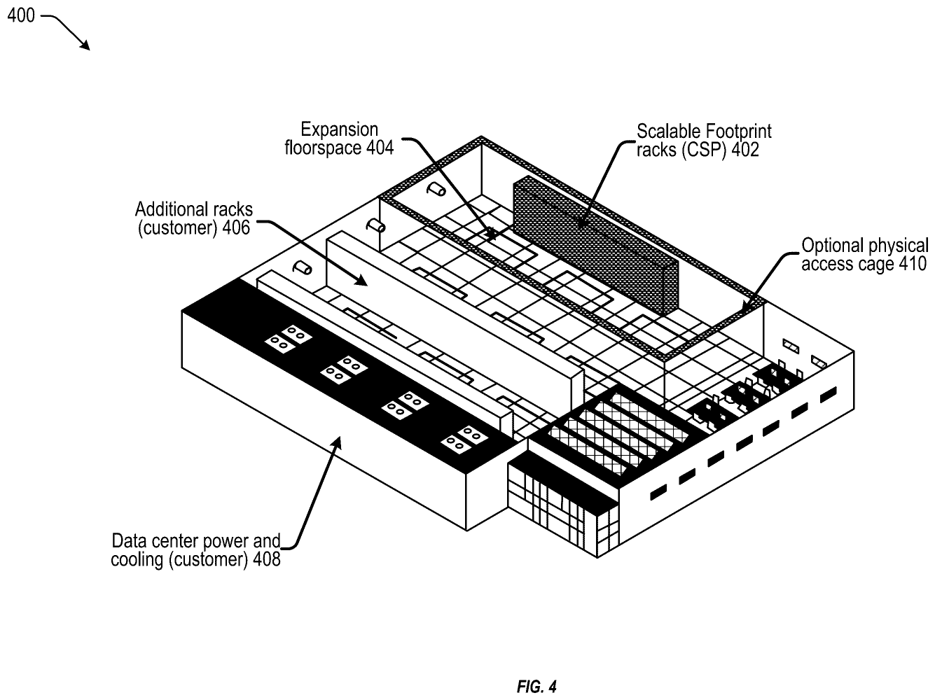

FIG. 4 is a diagram illustrating an example scalable footprint data center 400, according to some embodiments. The scalable footprint data center 400 can be a facility for hosting the components of a scalable footprint region, including the small footprint 300, medium footprint 302, and large footprint 304 of FIG. 3. The scalable footprint data center 400 can be a facility operated by a customer of the CSP. For example, the customer may desire having cloud services of the CSP available and sited close to the on-premises computing infrastructure of the customer to improve speed and network connectivity. The CSP can then deploy the scalable footprint racks within the scalable footprint data center 400. In some embodiments, the scalable footprint data center 400 can be a data center operated by the CSP, with no distinction between CSP and customer components as described below.

The scalable footprint data center 400 can include scalable footprint racks 402. The scalable footprint racks 402 can be examples of the scalable footprint racks described above, including the hyperconverged server rack 200 of FIG. 2. For example, the scalable footprint racks 402 can be a rack for a small footprint (e.g., small footprint 300 of FIG. 3) initial deployment at the scalable footprint data center 400. The scalable footprint data center 400 can include expansion floorspace 404 that can accommodate the expansion of the scalable footprint racks 402. For example, as a small footprint expands to a medium footprint, the additional server racks can be installed in the expansion floorspace 404. In some embodiments, the server racks providing CSP services can be protected by an optional physical access cage 410. However, data security features that are enabled for the hyperconverged architecture of the scalable footprint racks can allow the physical access cage 410 to be omitted even in customer-controlled scalable footprint data centers.

The scalable footprint data center 400 can also include additional racks 406 that provided computing resources of a customer's on-premises network. In embodiments where the scalable footprint data center 400 is operated by the CSP, the additional racks 406 may be server racks for scaling the footprint to a large footprint (e.g., large footprint 304 of FIG. 3). The scalable footprint data center 400 can also include power and cooling 408. The power and cooling can be sufficient for the number of racks for both the scalable footprint region and/or the customer's on-premises network.

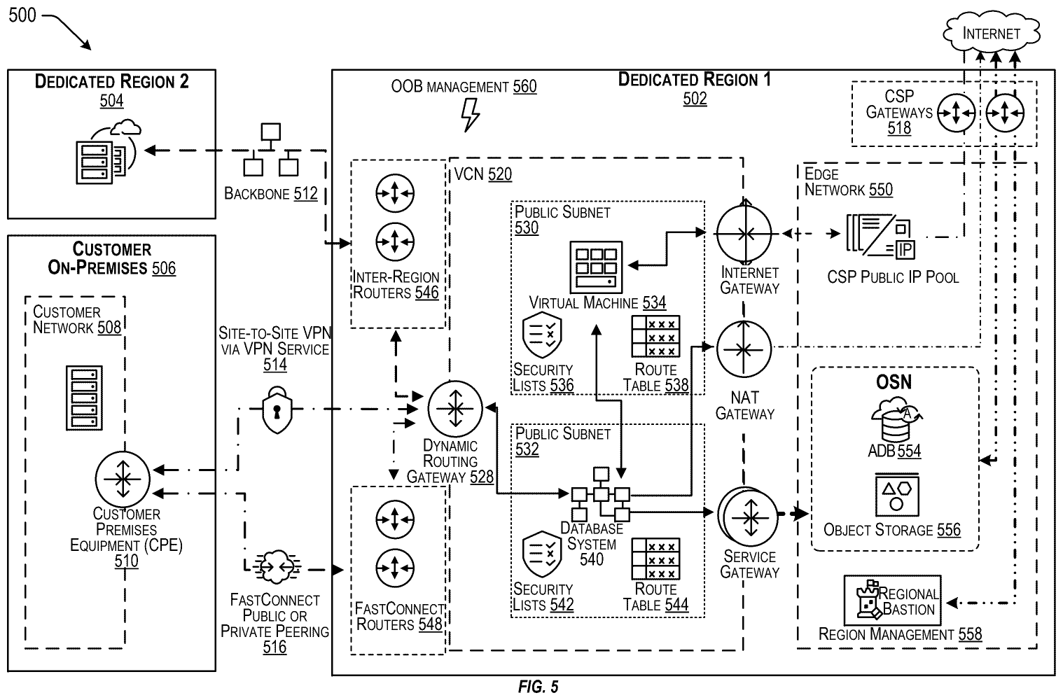

FIG. 5 is a block diagram illustrating an example physical networking infrastructure 500 for regions including scalable footprint data centers, according to some embodiments. A dedicated region 502 can be configured to provide infrastructure for hosting CSP services and/or customer applications according to the patterns described herein. The pattern for networking infrastructure 500 depicted in FIG. 5 can include connections to other dedicated regions (e.g., dedicated region 504), customer on-premises computing resources 506, and other cloud services of the CSP. Connections to another dedicated region 504 can be via a backbone 512 network connection, which can include backbone internet connections between data centers hosting the dedicated region 502 and the dedicated region 504. Connections to customer on-premises infrastructure 506 can be via site-to-site VPN 514 or a private physical network connection like FastConnect 516, which can be implemented using either public or private peering. The site-to-site VPN 514 can be provided by a VPN service which can be hosted in the dedicated region 502 or by the CSP in another cloud environment. Connections to the cloud from the dedicated region 502 can be via CSP gateways 518. The customer on-premises infrastructure 506 can include the customer network 508, connecting with customer-controlled computing resources including additional server racks (e.g., additional racks 406 of FIG. 4). The customer's on premises infrastructure 506 can be accessed via gateways of the customer premises equipment 510.

In some examples, the dedicated region 502 can connect to the CSP services via the Internet using CSP gateways 518. The CSP can provide operational support (e.g., monitoring, network management, etc.) for the dedicated region 502 using the same network connection. Connectivity between the dedicated region 502 and the CSP can be implemented via direct network peering to the CSP gateways 518. In some examples, the CSP gateways 518 can provide always-on distributed denial of service (DDoS) detection and mitigation for common layer 3 and 4 volumetric DDOS attacks, such as SYN, UDP, and ICMP floods and NTP amplification attacks. In some embodiments, the CSP gateways 518 can be provided in the point of presence (POP) associated with the scalable footprint data center. In some embodiments, the CSP gateways can be provided in the dedicated region 502 to enable direct peering.

In some examples, the dedicated region 502 can connect to another dedicated region 504 via the backbone 512. The backbone 512 can act as a public peering path between dedicated region 502 and dedicated region 504. The backbone 512 can also act as a private peering path between VCNs across regions. For example, VCN 520 can be peered with a VCN within dedicated region 504. In some examples, peering links between dedicated region 502 and dedicated region 504 can be used to setup disaster recovery operations between the regions. The backbone 512 can use redundant and diverse networking paths from different service providers (e.g., ISPs). The backbone 512 can provide suitable bandwidth to support the connectivity of dedicated regions. For example, the backbone 512 can provide one or more 10 or 100 Gbps links. In some examples, traffic (e.g., layer 2 traffic) over the backbone 512 can be encrypted using a security protocol (e.g., MACsec). The CSP can manage encapsulation and isolation of traffic over the backbone 512 for different tenancies (e.g., different customers) in both dedicated region 502 and dedicated region 504. Routing between the dedicated regions can be enabled by inter-region routers 546.

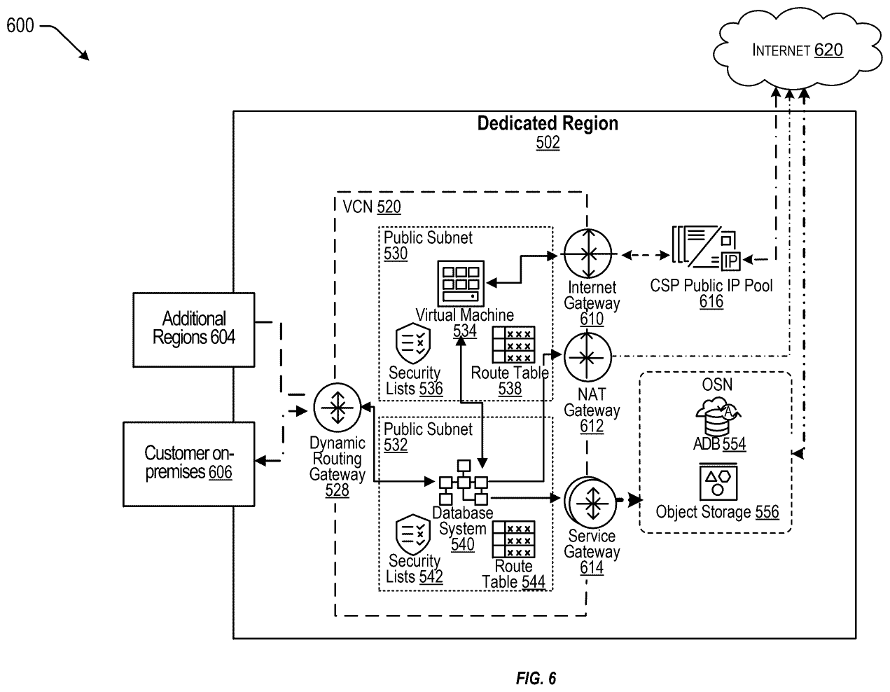

In some examples, the dedicated region 502 can be connected to the customer's on-premises infrastructure 506 using a site-to-site VPN 514 or a private physical connection like FastConnect 516. The private physical connection can be provided by the CSP via provided hardware including FastConnect routers 548. The connection between the dedicated region 502 and the on-premises infrastructure 506 can used to migrate applications from the on-premises infrastructure 506 to the dedicated region 502. For example, a customer operating its own data center can implement a scalable footprint region in the data center (e.g., scalable footprint data center 400 of FIG. 4) to expand the capabilities and functionality of the cloud resources. As part of the implementation, applications that were previously hosted on customer on-premises infrastructure 506 can be moved to customer infrastructure in the overlay network of the dedicated region 502. In some examples, the customer on-premises infrastructure 506 can be used to split compute workloads between the customer network 508 and the dedicated region 502. Border gateway protocol (BGP) routing can advertise VCN CIDR routes or a subset of routes between the customer on-premises infrastructure 506 and the dedicated region 502 via a dynamic routing gateway (DRG) 528 and FastConnect routers 548. Details of the DRG 528, as well as the other virtual networking components like the internet gateway, network address translation (NAT) gateway, and the service gateway that are accessible from VCN 520, are provided below with respect to FIG. 6.

In the scalable footprint data center, CSP services and customer applications can execute in one or more VCNs, including VCN 520. The VCN 520 can exist in the Overlay network. The Overlay network can include additional VCNs not depicted in FIG. 5.

The VCN 520 can include multiple subnets, including public subnet 530 and public subnet 532. For example, public subnet 530 can include virtual machine (VM) 534, which can be configured to host processes and applications for performing compute operations in the dedicated region 502. The public subnet 530 can have security lists 536 defining security rules for ingress and egress traffic to/from the endpoints of the public subnet 530. The public subnet 530 can also include a route table 538 that includes known routes to endpoints within the dedicated region 502.

Similarly, public subnet 532 can include security lists 542 that define security rules for ingress and egress traffic to/from the public subnet 532. The security list 542 can define different security rules than security lists 536. The public subnet can have a route table 544 that includes the known routes to endpoints within the dedicated region 502. The public subnet 532 can include a database system 540. The database system 540 can be configured to provide data persistence and retrieval. For example, VM 534 can use database system 540 to persist data generated by VM 534. Database system 540 can connect to storage devices of the hyperconverged server devices that provide database storage. For example, the CSP service network can include autonomous database service 554 and object storage service 556 that provide data storage capabilities within the dedicated region 502. In some examples, the service network can be in an edge network 550 of the dedicated region 502.

In addition, to the components described above, the underlay network of the dedicated region 502 can include various devices and other networking endpoints that are connected via the physical networking components of the scalable footprint data center. The underlay network can include, without limitation, ILOM(s), Bastions (e.g., region management bastion 558), NTP server(s) (e.g., NTP service provided on a BIOS device), BIOS services, and VNIC(s). The ILOM(s) can be computing devices and network targets that provide access to the server devices of the dedicated region 502 for both in-band and out-of-band management. For example, the ILOM(s) can allow for remote management of the associated server devices within the server racks that is separate from the networking pathways defined for the region. The Bastions can be services executing on the server devices of the scalable footprint data center that provide network access via the underlay network and do not have public network addresses. The Bastions can provide remote access to computing resources within the dedicated region 502 in conjunction with a Bastion service that operates on the underlay network. Similarly, network time protocol (NTP) services may operate in the underlay network to provide accurate timing to devices and services within the dedicated region 502. BIOS services can include services that are hosted on the one or more BIOS devices on the hyperconverged server racks of the scalable footprint data center. As one example, the BIOS services can include a key encryption service usable to encrypt/decrypt data on the server devices of scalable footprint data center during the initial boot process. As another example, the BIOS services can include a network configuration service that can provide the initial network configuration for devices within the scalable footprint data center. The VNIC(s) can include network interfaces defined by SmartNICs connected to the server devices within the dedicated region 502.

In addition to management provided via region management 558 via bastions, a CSP can provide management and monitoring of resources in the dedicated region 502 via out-of-band (OOB) management connection 560. The OOB management connection 560 can be a last resort recovery connection using a direct internet access server. The direct internet access server can be deployed off the main network of the dedicated region 502. For example, the OOB management connection 560 can be via a server connected to a specific port of one TOR of a hyperconverged server rack in the dedicated region 502. The OOB management connection 560 can have terminal service connection to the edge routers of the dedicated region 502. The CSP can use narrow access control lists (ACLs) and strong authentication protocols for connections over the OOB management connection 560, thereby limiting the sources of inbound connections to the dedicated region 502 over the OOB management connection 560. Because the OOB management connection 560 dedicated server is not in the edge network of the dedicated region 502, it can use network address space from an ISP and can remain a viable pathway to the dedicated region 502 even in situations when the internal networking configuration of the dedicated region 502 fails.

FIG. 6 is a block diagram illustrating an example architecture 600 for networking in a scalable footprint data center including dedicated region 502, according to some embodiments. The architecture 600 can be an example of the infrastructure 500 of FIG. 5. As described above with respect to FIG. 5, the dedicated region 502 can connect to additional regions 604 as well as customer on-premises infrastructure 606, which can be examples of dedicated region 504 and customer on-premises infrastructure 506, respectively.

Each VCN in the dedicated region 502 can include networking components that allow for connections between locations in the dedicated region 502. Using VCN 520 as an example, these networking components can include the DRG 528, an Internet gateway 610, a NAT gateway 612, and a service gateway 614.

In some examples, the Internet gateway 610 can provide direct connectivity to the public Internet 620 for resources in the VCN 520. The Internet gateway 610 can be instantiated for the VCN 520 by the customer operating the VCN 520. That is to say, not every VCN in the dedicated region 502 may have an Internet gateway 610 to provide networking connection to the Internet 620. Resources in the VCN 520 (e.g., VM 534) can be in a public subnet (e.g., public subnet 530) with public IP addresses. The route table 538 and security lists 536 can control the types of traffic allowed in and out of the resources to/from the Internet 620. The Internet gateway 610 can support connections initiated from within the VCN 520 (egress) and connections initiated from the Internet (ingress). Endpoints addressable with the Internet gateway 610 can include IP addresses of the CSP's public IP pool 616.

In some examples, the NAT gateway 612 can provide private subnet instances access to the Internet 620. These instances can initiate connections to the Internet and receive responses, but the NAT gateway 612 can be configured to not allow inbound connections initiated from the Internet 620. The NAT gateway 612 can be highly available and support TCP, UDP, and ICMP ping traffic.

In some examples, the service gateway 614 can provide connections for resources in the VCN 520 to CSP services. The CSP services can be in the dedicated region 502. The CSP service network can include endpoints for CSP services that have public IP addresses. The service gateway 614 can be configured to provide a private path to these CSP service endpoints.

In some examples, the DRG 528 can enable remote peering within and between regions (e.g., additional regions 604) and to customer on-premises infrastructure 606. Customers of the CSP can control the routes that are advertised using the DRG 528. In addition, identity and access management (IAM) policies can be implemented for peering between VCNs using a DRG. For example, VCN 520 can peer with another VCN in the dedicated region 502 using DRG 528 and a suitable IAM policy to authenticate the resources that connect between the VCNs.

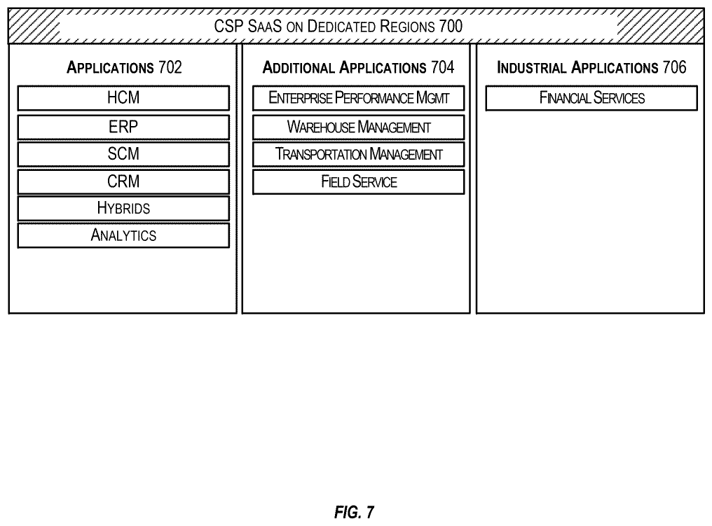

FIG. 7 is a block diagram illustrating example software-as-a-service (SaaS) applications 700 that can be provided from a scalable footprint data center, according to some embodiments. The scalable footprint data center providing the SaaS applications 700 can be an example of the scalable footprint data center 400 of FIG. 4, including any of the scalable region footprints described herein.

The SaaS applications 700 can include applications 702, additional applications 704, and industrial applications 706. The applications 702 can include human capital management solutions, enterprise resource planning, supply chain and manufacturing applications, customer relationship management, hybrid solutions, and analytics applications for analyzing data from one or more of the SaaS applications provided in the scalable footprint data center environment. The additional applications 704 can include enterprise performance management, warehouse management applications, transportation management solutions, and field service applications. Industrial applications 706 can include various financial services. The SaaS applications can be provided on customer-specific basis and can be hosted in corresponding customer tenancies in the overlay network of the scalable footprint data center.

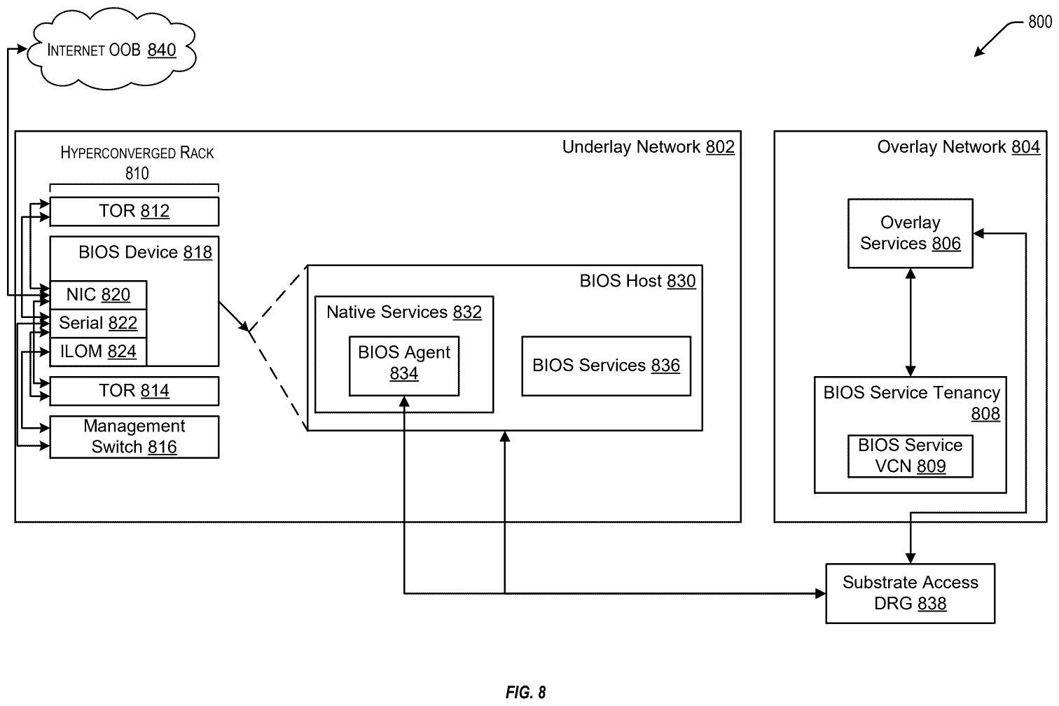

FIG. 8 is a block diagram illustrating a BIOS server architecture in a scalable footprint data center 800, according to some embodiments. The scalable footprint data center 800 can include an underlay network 802 and an overlay network 804. The services and other processes operating in the overlay network 804 can communicate with devices in the underlay network via a substrate access dynamic route gateway (DRG) 838, which can be an example of the DRG 528 described above with respect to FIG. 5 for a particular case of the VCN 520 that is a substrate access VCN. The substrate access VCN can be configured to provide networking routes between one or more other VCNs (e.g., customer VCNs) and the networking devices (e.g., SmartNICs) and other networking components of the substrate services that now execute in their own VCN in the overlay network.

The underlay network 802 can include a portion of multiple hyperconverged racks, including hyperconverged rack 810. The hyperconverged rack 810 may be an example of the hyperconverged rack 200 described above with respect to FIG. 2. The underlay network 802 can include the physical components of the hyperconverged rack that form the network of devices for managing the vestigial “substrate” services that are not moved into the overlay network (e.g., overlay network 804) in the scalable footprint region architecture. For example, the underlay network 802 can include the portion of hyperconverged rack 810 that has the switches (e.g., TOR 812, TOR 814, management switch 816) and bare metal server device configured as a BIOS device (e.g., BIOS device 818), while other components of hyperconverged rack 810 may be part of the overlay network 804 (not depicted in FIG. 8.). For instance, the server devices of hyperconverged rack 810 that host Compute VMs for use by overlay service 806 or customer applications may be part of the overlay network 804.

Hyperconverged rack 810 can include TOR 812, TOR 814, management switch 816, and BIOS device 818. TOR 812 and TOR 814 may be examples of TOR 206 and TOR 208 of FIG. 2. TOR 812 and TOR 814 may be configured to provide switching functionality (e.g., Layer 2 and/or Layer 3 switching) for network traffic to/from the computing devices of hyperconverged rack 810 and to other computing devices in the scalable footprint data center 800. In some embodiments, TOR 812 can be connected to one or more of the server devices (e.g., server devices 204 of FIG. 2) of hyperconverged rack 810, while TOR 814 can be connected to one or more other server devices of hyperconverged rack 810. In some examples, TOR 812 and TOR 814 can be connected to each computing device of hyperconverged rack 810. TOR 812 and TOR 814 can also be connected to other networking devices of the scalable footprint data center 800, including TORs of additional hyperconverged racks. In this way, the computing devices of the racks in scalable footprint data center 800 can be connected together to allow routing of network traffic to/from the various computing devices. The management switch 816 can connect to ILOM interfaces at the computing devices of hyperconverged rack 810 to allow for network access to the computing devices in the event of a failure of networking devices in the scalable footprint data center 800, including TOR 812 or TOR 814.

BIOS device 818 can include a network interface controller (NIC) 820, a serial interface 822, and ILOM 824. The NIC 820 can provide a physical networking interface to the TOR 812, TOR 814, or the out of band Internet connection 840. The NIC 820 can include interfaces for various physical networking connections, including small form-factor pluggable (SFP), quad small form-factor pluggable (QSFP), modular connections, and the like. The NIC 820 can support network connections using various networking protocols, including Ethernet, FibreChannel, and the like. The NIC 820 can connect the BIOS device 818 to both TOR 812 and TOR 814, using separate interfaces. NIC 820 can also provide an interface to connected BIOS device 818 to a public network (e.g., the Internet) via an out-of-band (OOB) channel 840. The OOB connection can allow for access to the BIOS device 818 from the public network in the event of a loss of network connectivity to or within the scalable footprint data center 800. The OOB connection may have restrictions for which authorized systems may connect to the BIOS device 818 over the OOB channel. In some embodiments, only BIOS device 818 may have a network connection to the Internet OOB 840, so that BIOS devices of other hyperconverged racks in the scalable footprint data center do not have network connections to the Internet OOB 840. In other embodiments, additional BIOS devices can also include a network connection to the Internet OOB 840.

The serial interface 822 can provide a direct connection between the BIOS device 818 and the switches in hyperconverged rack 810, including TOR 812, TOR 814, and management switch 816. The serial interface 822 can provide the BIOS device 818 with command line access to the switches to allow for configuration of the switches in the event that the switches are not reachable via the typical networking protocol (e.g., the networking configuration within hyperconverged rack 810 is faulty).

As discussed briefly above, the scalable footprint data center 800 can include multiple BIOS devices. In some configurations, each rack in the scalable footprint data center 800 can include a single BIOS device. In other configurations, a single rack can include three BIOS devices. For redundancy in the event of a failure of a BIOS device, a scalable footprint data center can include a minimum of three BIOS devices, any one of which is sufficient to bootstrap the recovery of an entire region of the scalable footprint data center.

Each BIOS device in the scalable footprint data center 800 can host a bare metal instance of software applications, processes, and/or services to support the initial startup of the scalable footprint data center 800 or the recovery of the scalable footprint data center 800 from a shutdown or failure state. As depicted in FIG. 8, BIOS device 818 can include BIOS host 830, which may be an exemplary software architecture for a BIOS device in the scalable footprint data center 800. BIOS host 830 can be a bare metal instance executing on the BIOS device 818, including an operating system, native service 832, and BIOS services 836. The native service 832 can include BIOS agent 834 as well as a PKI agent and a deployment orchestrator agent for deploying and managing containers within the BIOS host 830 (e.g., an orchestrator for a container engine like Docker or Kubernetes). The native service 832 may be software configured as part of the software image for the BIOS device 818 and may execute automatically whenever the BIOS device 818 is powered on. The BIOS agent 834 may be configured to perform operations for starting the BIOS service 836 and receiving instructions from services in the overlay network 804 (e.g., overlay services 806) for controlling the BIOS services 836.

The BIOS services 836 can include the vestigial “Substrate” services that remain in the underlay network 802 without being implemented in the overlay network 804 in the scalable footprint data center 800. The BIOS services 836 can include a domain name system (DNS) service, a dynamic host configuration protocol (DHCP) service, a network time protocol (NTP) service, a border gateway protocol (BGP) service, a key exchange service (KES), a compute snapshot service, and a VCN snapshot service. The DNS, DHCP, NTP, and BGP services can be configured to provide networking functionality within the scalable footprint data center 800 of DNS, DHCP, NTP, and BGP services known in the art. The KES can be configured to perform fundamental key generation, key exchange, and related cryptographic operations to support the vending of decryption keys to computing devices within the scalable footprint data center 800 during initial startup or during recovery operations. For example, a KES of the BIOS services 836 on BIOS device 818 can be configured to vend keys to server devices within the hyperconverged rack 810 to decrypt local boot volumes at those server devices for use during the initial boot of bare metal instances and/or hypervisors and VMs executing on the server devices.

The overlay network 804 can include overlay services 806 and a tenancy for the BIOS service, BIOS service tenancy 808. As described above, the overlay services 806 can include the “core” Substrate services that are moved from bare metal instances in the underlay network 802 in a conventional data center environment to the overlay network 804 in a scalable footprint data center 800. The overlay services 806 can include Compute service control plane, a public key infrastructure (PKI) service, a Certificates service, an Identity service, a deployment orchestration service, and other services for deploying and configuring infrastructure components in the scalable footprint data center 800.

The BIOS service tenancy 808 may define a portion of the infrastructure resources of the overlay network 804 that is reserved for the BIOS service. For example, a BIOS control plane may be implemented in a BIOS service VCN 809, which can include one or more VMs executing within the overlay network 804 to host the processes of the BIOS control plane. The BIOS control plane can communicate with the BIOS services 806 via BIOS agent 834 to perform operations for maintaining the BIOS services 836 during steady state operation of the scalable footprint data center 800.

### Building a Butterfly Network Using a Prefab Factory

As described above, the components of a scalable footprint data center (e.g., a Butterfly region, including scalable region footprint 130) can be initially configured in a prefab factory. The prefab factory can centralize the process of building a Butterfly region to provide more efficient use of computing and networking resources that support region build. For example, the prefab factory may be sited “close” (e.g., with low-latency and high data rate networking connections) to a host region that includes the prefab services and/or a ViBE. One or more prefab services, including, for example, an orchestration service, reconfiguration service, and replicator service, can be hosted by a CSP that can manage bootstrapping (e.g., provisioning and deploying software to) infrastructure components for one or more Butterfly regions within the prefab factory. The orchestration service can then orchestrate the provisioning of the Butterfly region infrastructure and deployment of software resources to the Butterfly infrastructure.

The prefab factory can be a facility similar to a data center, including sufficient power, cooling, and networking infrastructure to support building one or more regions. The prefab factory may be located in proximity to existing computing infrastructure of a CSP. A Butterfly region being built in the prefab factory can include the hyperconverged racks for initial footprint, including, for example, three hyperconverged racks, four hyperconverged racks, six hyperconverged racks (as depicted in FIG. 1), or even as few as a single hyperconverged rack. The prefab factory may be connected over one or more networks to services provided by a CSP. During region build operations, the CSP supporting prefab operations can provision infrastructure components on the physical resources of the Butterfly region and deploy software resources, configurations, and/or other artifacts to the provisioned infrastructure components. The prefab region may be brought to a state that is close to the final production state of the devices when they are installed at the destination facility. The Butterfly region can then be configured for transportation to the destination site and then delivered and installed at the destination site. For example, a customer facility can receive a Butterfly region configured in a prefab factory for use as a scalable footprint data center in the customer facility.

For Butterfly regions built in a prefab factory, the prefab services can perform operations to deploy the software resources to the physical components (e.g., server devices 204 of FIG. 2) using device images. For example, a template Butterfly region can be built with individual infrastructure and software components deployed in an orchestrated manner. Once built, each device of the template Butterfly region can be imaged to create an image set that corresponds to the network topology and hardware configuration of the template Butterfly region. Image sets can therefore be generated for different “shapes” of Butterfly regions, for instance the three-, six-, or 12-rack configurations. In some cases the building of the template Butterfly region can occur in a production region (e.g., the host region). For example, the host region can be connected to racks for the template Butterfly region, build a ViBE, deploy the software to the racks, perform pre-imaging configurations, image the racks, and store the image set on a suitable storage device. In some cases, building the template Butterfly region can occur in the prefab factory connected to the host region.

The general process flow for building a Butterfly region at a prefab factory can proceed as follows. First, an existing production region (e.g., a host region) can build a template Butterfly region in a manner that produces a minimal amount of metadata associated with services and the specific realm in which the production region exists. A “realm” may be a further abstraction of a “region” that provides a logical grouping of regions including defining a realm-specific namespace for domain names and other identifiers within the regions of the realm. For example, the production region used to build the template Butterfly region can be in a particular realm, but the template Butterfly region is built so that services that are deployed in the template Butterfly region are agnostic to both the realm and the production region. In particular, identifiers for software resources in the template Butterfly region can be static identifiers that do not explicitly reference the current realm and/or region of the template Butterfly region but can still be used in the deployed Butterfly region to obtain realm and region information and uniquely identify the corresponding software resource.

After the template Butterfly region is built, a reconfiguration process can be performed to aggressively reduce the amount of persisted data on the server devices within the template Butterfly region. Then, an image set can be created by copying the data from each computing device within the template Butterfly region to an image store. The image set can include device images for server devices (e.g., copies of the NVMe drives) as well as other computing and networking devices like SmartNICs, network switches, and BIOS devices. The image store can then be provided to the prefab factory (e.g., at some future time) and the image set deployed to the devices of the Butterfly region. After the new Butterfly region is built, another reconfiguration operation can be performed to update any deployed software artifacts to a current available state. The Butterfly region can then be shipped to a target facility (e.g., a scalable footprint data center), at which point a final reconfiguration process can be performed to update deployed software as well as adapt the Butterfly region to the networking environment of the scalable footprint data center.

Numerous advantages can be realized by building a scalable footprint data center (e.g., Butterfly region) in a prefab factory. In addition to the advantages provided by the Butterfly configuration itself, in which core services operate in the Overlay network, the prefab factory allows for rapid configuration of multiple Butterfly regions. The prefab factory can build multiple Butterfly regions sequentially or simultaneously. Deploying images to devices can occur significantly faster than deploying services to each node in a Butterfly region individually. Accordingly, a service provider offering image-based Butterfly region build operations according to the techniques described herein can substantially reduce the expenditure of computational resources.

The use of static identifiers can also provide advantages over conventional methods for establishing resource identifiers in a newly built data center environment. For example, conventional identifiers would require some form of rotation to replace identifiers that include inaccurate region and realm information with the correct information. Such a rotation would require substantial updates to the database tables that maintain the relationship between the identifier and the particular resource. Rather than performing a rotation operation, the static identifiers can be provided for use with the resources initially deployed during region build such that those static identifiers remain viable and usable within the region network after on-site reconfiguration.

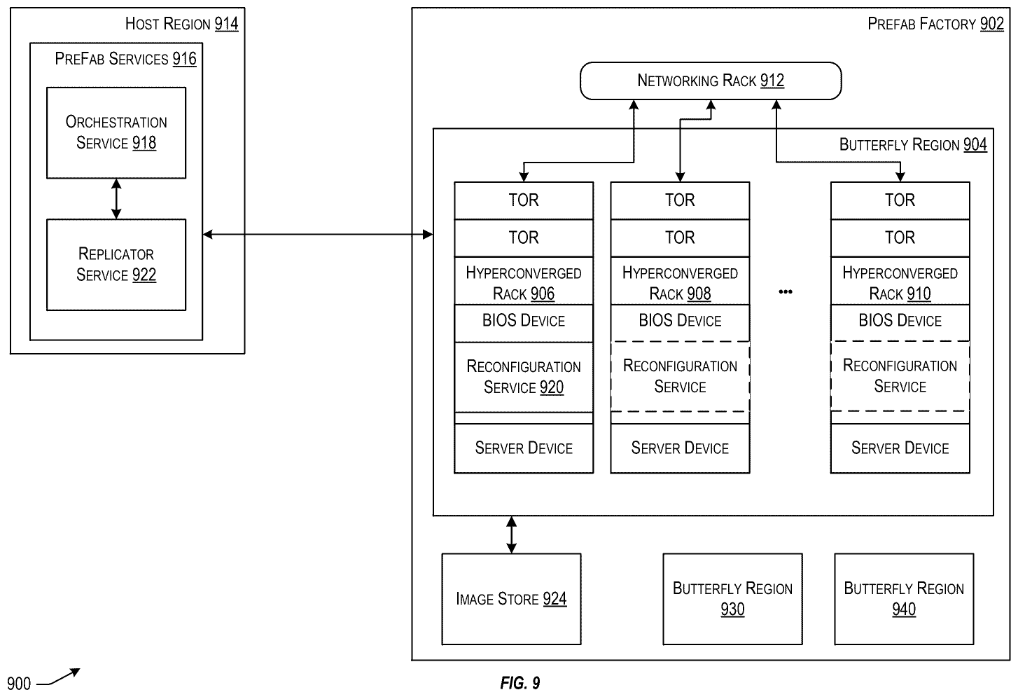

FIG. 9 is a block diagram illustrating an example architecture 900 of a prefab factory 902 in which a region network of a scalable footprint data center can be configured, according to some embodiments. The region network can be Butterfly region 904, which can include hyperconverged rack 906, hyperconverged rack 908, and hyperconverged rack 910. As described briefly above, the Butterfly region 904 can include any suitable number of hyperconverged racks according to a shape of the Butterfly region 904. For example, the Butterfly region 904 can include three-, six-, or 12-rack configurations. Each hyperconverged rack 906-910 may be an example of the hyperconverged rack 200 described above with respect to FIG. 2. For example, each hyperconverged rack 906-910 can include a BIOS device 202 and one or more server devices 204.

The prefab factory 902 can include a networking rack 912. The networking rack 912 can include one or more networking devices including switches, gateways, routers, and the like for communicatively coupling the hyperconverged racks 906-910 to each other and to other networking infrastructure of the prefab factory 902. As depicted in FIG. 9, the networking rack 912 may not be a component of the Butterfly region 904 but instead be a component of the prefab factory 902. In some embodiments, the networking rack 912 can be a component of the Butterfly region 904. In these embodiments, the devices of the networking rack 912 can be configured similar to the devices of the hyperconverged racks 906-910. For example, device images for networking devices like switches can be deployed to the components of the networking rack 912 as part of the build process for the Butterfly region 904.

The prefab factory 902 may interface with a host region 914. The host region 914 may be an existing region of a CSP that can provide cloud services, including prefab service 916 for performing operations related to building a region at the prefab factory 902. The prefab factory 902 can connect to the host region 914 via a network, which may be a public network like the Internet, a private network, or other network. The prefab services 916 can include an orchestration service 918 and a replicator service 922. The prefab services 916 can perform operations corresponding to building the Butterfly region 904 in the prefab factory 902, including deploying device images to the devices of Butterfly region 904, and configuring the network of the Butterfly region 904.

The orchestration service 918 can perform tasks to coordinate the operations of the prefab services 916, including scheduling Butterfly region build operations at the prefab factory 902 by other prefab services 916, scheduling reconfiguration processes performed by the reconfiguration service 920, triggering image deployment by the replicator service 922, and monitoring for status and capabilities indications received from deployed software in the Butterfly region 904. For example, the orchestration service 918 can determine whether an image set was successfully deployed to the devices of the Butterfly region 904 based on receiving indications that services in the Butterfly region 904 successfully started after deployment of the image set. The orchestration service 918 can also manage the steps of software deployment within a region, for instance to deploy software artifacts onto provisioned infrastructure within a region. For example, the orchestration service 918 may be configured to bootstrap (e.g., provision and deploy) services into a region (e.g., Butterfly region 904) based on predefined configuration files that identify the resources (e.g., infrastructure components and software to be deployed) for implementing a given change to the Butterfly region 904. These operations can occur during a reconfiguration process for the Butterfly region 904 that can occur in the prefab factory 902 or in a different data center environment like a scalable footprint data center at which the Butterfly region 904 is ultimately installed. The orchestration service 918 can parse and analyze configuration files to identify dependencies between resources. The orchestration service 918 may generate specific data structures from the analysis and may use these data structures to drive operations and to manage an order by which services are bootstrapped to a region. The orchestration service 918 may utilize these data structures to identify when it can bootstrap a service, when bootstrapping is blocked, and/or when bootstrapping operations associated with a previously blocked service can resume. The bootstrapping of a service can include updating a service to a currently released state.

In some embodiments, the orchestration service 918 may include components configured to execute bootstrapping tasks that are associated with a single service of a prefab region. The orchestration service 918 can maintain current state data indicating any suitable aspect of the current state of the resources associated with a service. In some embodiments, desired state data may include a configuration that declares (e.g., via declarative statements) a desired state of resources associated with a service. In some embodiments, orchestration service 918 can identify, through a comparison of the desired state data and the current state data, that changes are needed to one or more resources. For example, orchestration service 918 can determine that one or more infrastructure components need to be provisioned, one or more artifacts deployed, or any suitable change needed to the resources of the service to bring the state of those resources in line with the desired state.

The reconfiguration service 920 can be configured to manage region reconfiguration operations at various stages in the Butterfly region build operation at a prefab factory 902. The reconfiguration service 920 can be implemented on one or more of the BIOS devices of the Butterfly region 904. Reconfiguration operations can include updating deployed software resources (as orchestrated by orchestration service 918), removing extra data (e.g., unneeded metadata, sensitive information, log records) from a template Butterfly region prior to imaging, and adapting network configurations, including updated metadata to adapt the built Butterfly region at a destination data center environment.

The reconfiguration service 920 can expose an API accessible to server devices of the Butterfly region 904. The reconfiguration service 920 can track the stages of the reconfigurations operations and provide current stage status information to other services within the Butterfly region 904 or prefab services 916. For example, during a reconfiguration operation after deploying images to the Butterfly region 904, the services hosted in Butterfly region 904 can be updated based on a current release version of the service software. A service in the Butterfly region 904 undergoing reconfiguration can post current service state information to the reconfiguration service 920. The service can obtain a current stage of the reconfiguration operation from the reconfiguration service 920. Upon a change in the stage (e.g., triggering an update stage for services in the Butterfly region 904), the service can poll other services in the Butterfly region 904 for current state information of those other services, so that updates to the services can occur in a dependency-aware manner. The service can be updated and then provide a status of the update (e.g., succeeded, failed) to the reconfiguration service 920. The reconfiguration service 920 can then track the state of each service in the Butterfly region 904. Once the reconfiguration service 920 determines that each service has successfully completed the reconfiguration operations corresponding to the stage, the reconfiguration service 920 can indicate that the stage has been completed and proceed to a next stage. In some embodiments, if a reconfiguration operation for a service fails (as indicated to the reconfiguration service 920 by the service), additional automation from the orchestration service 918 or manual configuration can be applied to the service to complete the reconfiguration operation.

The replicator service 922 can be configured to perform operations for generating an image of a computing device in the Butterfly region 904. The replicator service 922 can generate images for each computing device in the Butterfly region 904, including the BIOS devices, server devices, SmartNICs, and networking devices. The replicator service 922 can connect to a server device through a console connection (e.g., an ILOM) and configure the server device to boot a live-image operating system. The live-image can include device image capture and replication software that can automatically execute when the server device boots using the live-image. The device image capture software can be configured to generate a device image from each attached persistent storage of the server device. For example, the image capture software can create a “bit-for-bit” replica of the 14 NVMe drives on a hyperconverged server device and store that image at an image store. The replication software can be configured to retrieve a stored device image and copy it to drive. The image capture and replication software can be configured with information that identifies the location at which to store/retrieve images for an image set. For example, an image store 924 can be connected to the Butterfly region 904 (or a template Butterfly region in a production region during) with a particular network name and/or network address that can be included with configuration information usable to connect to the image store. The replicator service 922 can provide the live-image to the server devices. The replicator service 922 can restart the server device, after which the device image capture and replication software can create an image from the device or retrieve and copy the image onto the device. The replicator service 922 can also monitor the computing device to track the progress of the image creation/deployment operation until the operation is complete. For example, the live-image and image creation/replication software can send status indications to the replicator service 922 associated with the status of the image creation/replication operation.

As noted above, the image set that is used for the Butterfly region 904 can be generated using a template Butterfly region that is built, in various embodiments, in a prefab factory (e.g., prefab factory 902) or another production region. The template Butterfly region can be identical to the corresponding Butterfly region to which the images are later deployed. In embodiments where the template Butterfly region is built in a data center environment of a production region (not at the prefab factory 902), the template Butterfly region can still connect to prefab service 916 to provide the reconfiguration and replication operations described above. In these embodiments, the image set for the template Butterfly region can be stored on a storage device that is subsequently brough to the prefab factory 902 for use in deploying the image set to the Butterfly region 904.

Device images can be stored on one or more storage devices of an image store 924. The image set can include the device images (e.g., bit-for-bit copies of storage devices) of the computing devices in a Butterfly region. In some examples, the image store 924 may be a large capacity network attached storage appliance configured with a zettabyte file system (ZFS). The image store 924 can be a large, rack-like collection of storage devices that provide sufficient storage for an entire Butterfly region. For example, a Butterfly region including three hyperconverged racks with 12 hyperconverged server devices can have an image set that is approximately 8 PB in size. In some embodiments, the image store 924 can include a ZFS appliance for each image set corresponding to a different shape of Butterfly region. For example, the image store 924 can include a ZFS appliance for a three rack Butterfly region, a second ZFS appliance for a six rack Butterfly region, and a third ZFS appliance for a twelve rack Butterfly region. In some embodiments, the image store 924 can include a ZFS appliance for different versions of software of the image set. For example, an image set of a Butterfly region can be generated infrequently, so that the versions of deployed software within the Butterfly region can correspond to stable release candidates of the services therein. In this way, different service teams for services available within a Butterfly region need not provide compatible services far into the future for an image set. After the latest image set is deployed to the Butterfly region 904, the reconfiguration service 920 can update the deployed software resources in the Butterfly region 904 to the latest available versions.

As shown in FIG. 9, the prefab factory 902 can perform region build operations for multiple Butterfly regions simultaneously and/or sequentially. For example, Butterfly region 930 and Butterfly region 940 may be built in the prefab factory 902 at the same time as Butterfly region 904. Each of Butterfly region 930 and Butterfly region 940 can have the same or a different shape (e.g., number of hyperconverged racks) from Butterfly region 904. The image sets stored on image store 924 can be used to build Butterfly region 930 and Butterfly region 940. For example, if Butterfly region 930 has an identical shape (e.g., same number of hyperconverged racks, same number of server devices) as Butterfly region 904, then the same image set from image store 924 can be used to build Butterfly region 930 as used to build Butterfly region 904.

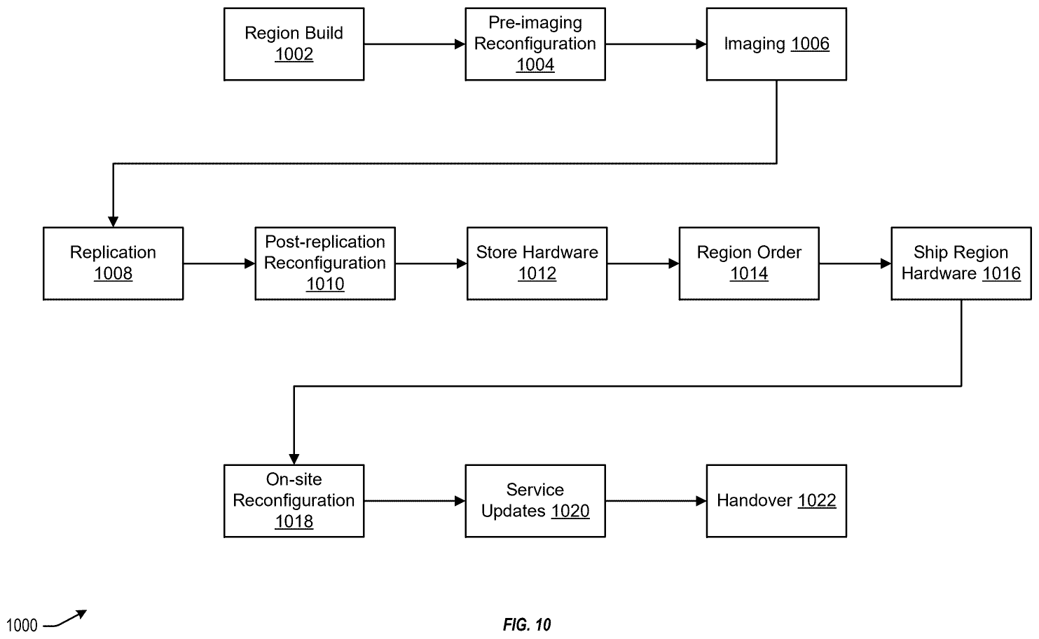

FIG. 10 is a block diagram illustrating an example process 1000 for configuring a region network (e.g., a Butterfly region 904 of FIG. 9) of a scalable footprint data center, according to some embodiments. The process 1000 may be performed by one or more components of a computer system, including one or more components of a computer system of a CSP that execute prefab services (e.g., prefab services 916 of FIG. 9) including an orchestration service, a reconfiguration service, and a replicator service. The operations of process 1000 may be performed in any suitable order, and process 1000 may include more or fewer operations than those depicted in FIG. 10.

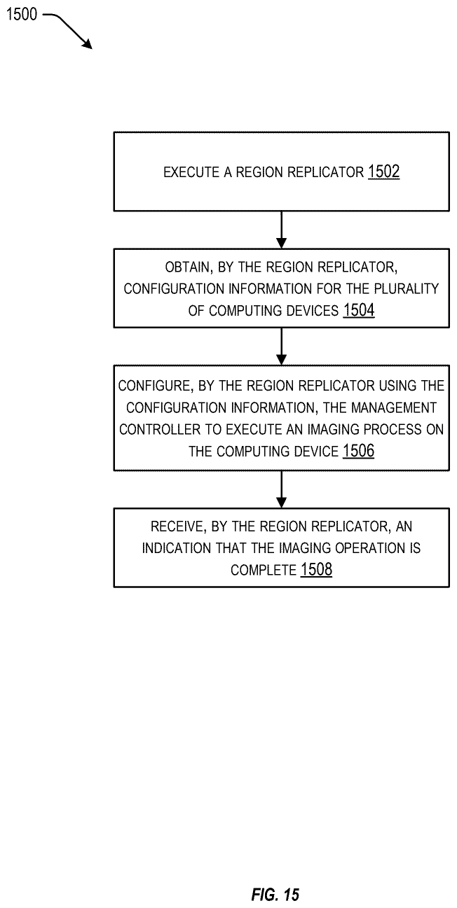

Some or all of the process 1000 (or any other processes and/or methods described herein, or variations, and/or combinations thereof, for example, process 1500 of FIG. 15) may be performed under the control of one or more computer systems configured with executable instructions and may be implemented as code (e.g., executable instructions, one or more computer programs, or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory.

The process 1000 includes operations that can broadly be grouped into three phases, with each block of process 1000 representing a stage or a sub-stage that is managed by the prefab services, including a reconfiguration service. Blocks 1002-1006 relate to building a Butterfly region, for example, a template Butterfly region, for use when creating an image set of the computing devices of that Butterfly region. Blocks 1008-1016 relate to building a Butterfly region at a prefab factory. Blocks 1018-1022 relate to on-site reconfiguration and the completion of the installation of the Butterfly region at a destination data center environment (e.g., a scalable footprint data center for a customer).

At block 1002, a region build process for a template Butterfly region can be performed. The region build process can include the provisioning of infrastructure components and deployment of software resources to the physical components of a template Butterfly region. For example, six hyperconverged racks of a template Butterfly region can be installed at a facility and communicatively connected to existing production region. As described above, in various embodiments, the template Butterfly region can be built at an existing region (e.g., the hyperconverged racks installed at an existing data center facility of a host region and connected to the host region network) or can be built at the prefab factory (e.g., the hyperconverged racks installed at the prefab factory and connected via a network connection to a host region). In this example, the existing production region can act as a host region in which a ViBE is generated to deploy the software resources into the six racks of the template Butterfly region. Specific details of exemplary methods for building a region using a ViBE can be found in U.S. Patent App. Pub. No. 2023/0251888, the entire contents of which are herein incorporated by reference in their entirety.

Once the template Butterfly region has been built, a pre-imaging reconfiguration process can occur, at block 1004. During pre-imaging reconfiguration, the reconfiguration service can orchestrate the execution of automation within the template Butterfly region to reduce the amount of persisted data within the template Butterfly region and to remove security related information (e.g., secrets, keys, certificates) that should not be kept as part of an image set. The reconfiguration service can orchestrate the pre-imaging reconfiguration per service in the template Butterfly region. For example, each service within the template Butterfly region can execute its own automation software to identify and remove excess data. In particular, log data can be removed from the template Butterfly region. By reducing the amount of data prior to image creation, the size of the image set for the template Butterfly region can be reduced as much as possible.

During the pre-imaging reconfiguration (or other reconfiguration operations described below including post-replication reconfiguration and on-site reconfiguration) the services within the template Butterfly region can be configured to stop accepting requests. For example, a load balancer for a service in the template Butterfly region can be disabled to prevent that service from receiving requests. In this way, the services may not change their state or create new data while the reconfiguration process is occurring. After reconfiguration is complete, the services can be configured to resume accepting request traffic (e.g., re-enable a front-end load balancer).

At block 1006, the reconfiguration service can initiate the imaging process. A replicator service (e.g., replicator service 922 of FIG. 9) can create images for each computing device in the template Butterfly region. An image store (e.g., image store 924 of FIG. 9) can be connected to the template Butterfly region. As described above, the replicator service can connect to a server device of the template Butterfly region through a console connection (e.g., an ILOM) and configure the server device to boot a live-image operating system. The live-image can include device image capture software that can automatically execute when the server device boots using the live-image. The device image capture software can be configured to generate a device image from each attached persistent storage of the server device. The image capture software can be configured with information that identifies the network location of the image store at which to store the device images. The replicator service can provide the live-image to the server devices. The replicator service can restart the server devices and other devices of the template Butterfly region, after which the device image capture software can create an image from the device.

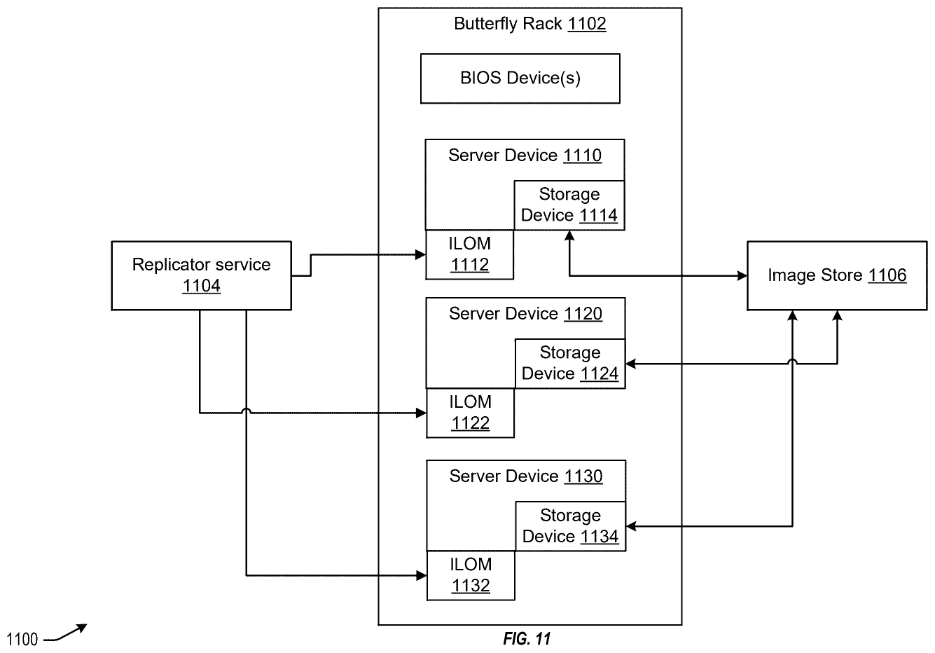

The second phase occurs at the prefab factory. At block 1008, replication of a Butterfly region image set to new physical components of a Butterfly region (e.g., Butterfly region 904 of FIG. 9) can occur. The physical components can be installed in the prefab factory and connected to the network environment of the prefab factory. The image store storing the image set for the Butterfly region can be connected to the prefab factory networking environment. The reconfiguration service can initiate the replication process. Similar to the process for image creation, the replication process can be orchestrated by a replicator service. The replicator service can connect to the computing device of the Butterfly region through a console connection (e.g., an ILOM) and configure the devices to boot a live-image operating system. The live-image can include replication software that can automatically execute when the device boots using the live-image. The replication software can be configured to retrieve a device image from the image set stored at the image store and copy the image to the drives of the device. Additional details about the replication process are provided below with respect to FIG. 11.

At block 1010, the reconfiguration service can initiate a post-replication reconfiguration of the Butterfly region. After images are deployed to the Butterfly region, updates to the services in the Butterfly region can occur via the orchestration service. In addition, images for other hardware components in the Butterfly region, particularly SmartNICs can be deployed to the storage components of those devices. Hardware metadata can also be updated and stored in the Butterfly region. For example, metadata that identifies the specific physical components of the Butterfly region can be updated, since, while identical, the Butterfly region's components are distinct from the template Butterfly region components used to create the image set. The hardware metadata can include device identifiers, media access control addresses, and other unique hardware information corresponding to the devices in the Butterfly region. In some examples, certificates used by services in the Butterfly region can be rotated (e.g., new certificates issued and signed). Certificates issued within the Butterfly region can be configured to have lifetimes corresponding to an estimated time until the Butterfly region is installed at the destination data center environment. For example, if the Butterfly region built in the prefab factory will be delivered to and installed at a customer data center environment within six months, the certificates issued to services in the Butterfly region during the post-replication reconfiguration process can be configured to expire in six months. When the Butterfly region is then started at the destination data center environment, the services may have functional, non-expired certificates for use during initial operations of the Butterfly region.

At block 1012, the built and configured Butterfly region can be stored. For example, the hyperconverged racks of the Butterfly region can be placed into a warehouse or other facility near the prefab factory. At block 1014 and block 1016, an order for a Butterfly region can be received by the CSP and the corresponding Butterfly region can be retrieved from storage and shipped to a destination data center environment (e.g., a customer data center).

Once the Butterfly region arrives at the destination data center, the physical components can be installed and connected to the network of the destination data center environment. Once powered on, the reconfiguration service can receive an indication from the Butterfly region that the devices and services in the Butterfly region are prepared for on-site reconfiguration, at block 1018. The reconfiguration service can then initiate the on-site reconfiguration process. On-site reconfiguration can include the installation of necessary secretes, keys, and other cryptographic information for device-device and/or service-service communication within the Butterfly region. For example, some credentials or root certificates may have been removed from the region during pre-imaging reconfiguration process, so that these secrets are not persisted in the image set for Butterfly region build at the prefab factory. New credentials can be provided to the services in the Butterfly region.

The on-site reconfiguration can also include configuring the services in the Butterfly region to join the realm corresponding to the destination data center environment and configure network addresses, domain names, service identifiers, certificates, and other networking endpoint information to comply with the new region and realm of the destination data center environment. For example, all IP addresses of the Butterfly region can be rotated from addresses provide on the image set in the prefab factory to new IP addresses for the network of the destination data center environment. The reconfiguration can occur on a per-service basis. For example, each service in the Butterfly region can query the reconfiguration service for the status of the reconfiguration process and based on that status, retrieve updated information like service certificates from an appropriate cloud service (e.g., rotated and newly signed certificate from a certificates service). As each service completes portions of its reconfiguration process, the service can provide its status to the reconfiguration service.

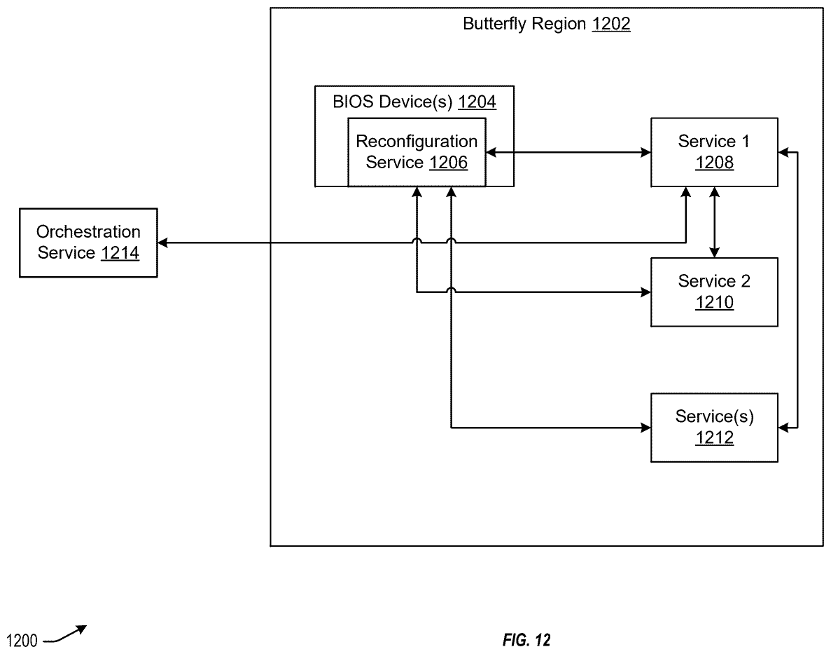

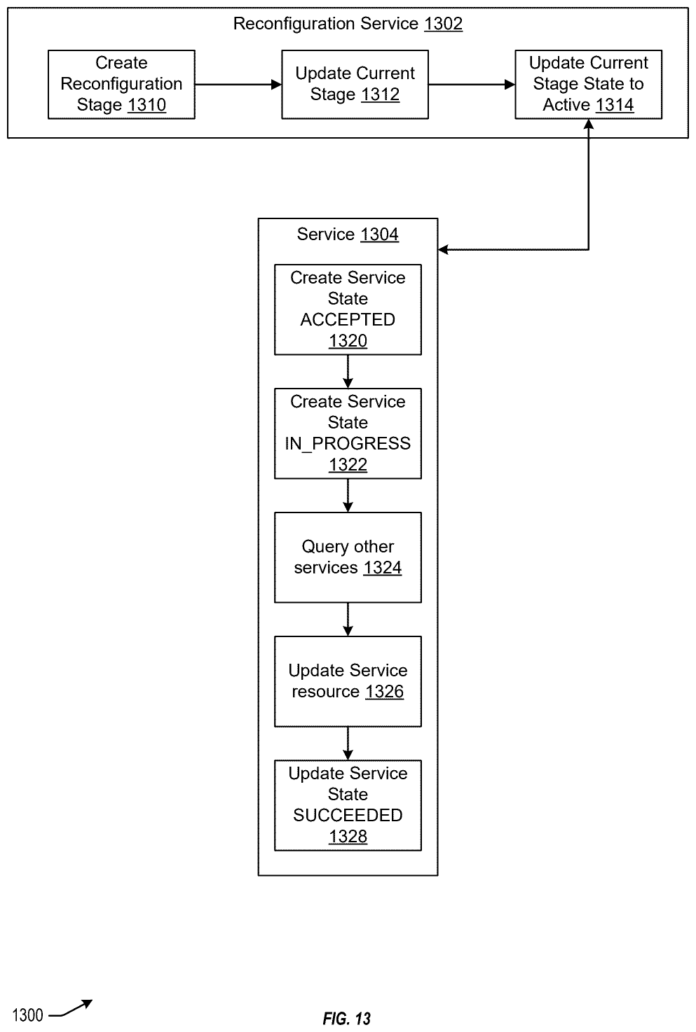

As a particular example of the per-service reconfiguration and interaction between the service and the reconfiguration service, when the on-site reconfiguration stage is advertised as the current stage by the reconfiguration service, the reconfiguration service can create a service record under the stage in an “IN-PROGRESS” state and uses the stage payload to perform service reconfiguration, adapting the service deployment to the new region and realm. During reconfiguration, the reconfiguration service can create a properties file containing updated environment variables on the host device in the Butterfly region. The configuration service can then initiate a restart of the service. An application startup script for the service can retrieve the environment properties file. The service can then provide an indication to the reconfiguration service that the reconfiguration has completed. The reconfiguration service can then update the service record for the stage to “SUCCEEDED.” Additional details of the reconfiguration process are provided below with respect to FIGS. 12 and 13.

After on-site reconfiguration, the Butterfly region should be functioning normally within the new network environment at the destination data center. However, service software in the Butterfly region may be out of date owing to the time elapsed between building the Butterfly region at the prefab factory and on-site reconfiguration at the destination data center. At block 1020, the reconfiguration service can initiate service updates. Each service in the Butterfly region can be updated, via an orchestration service, with current software resources of the most recent release of the service (e.g., most recent version of the artifacts of the service).

In some embodiments, the service updates may be cumulative updates that correspond to a relatively infrequent breakpoint, for example every quarter or every six months. Because updated versions of services and other software may need to maintain backwards compatibility with older versions of the software, and because the time period between building a Butterfly region image set, deploying the image set to the physical components, and then installing the Butterfly region at the destination data center can be relatively long, the window for maintaining backwards compatibility for service versions can also be relatively long. To avoid this issue, the cumulative update for the Butterfly region services can represent a most recent breakpoint version of the software resources that are guaranteed to be compatible with any later versions of the software resources. The cumulative update can be deployed to the Butterfly region, after which each individual service can receive any further updates to the most recent version of the service software. In this way, the service updates can be performed substantially in parallel, reducing the time to update the Butterfly region after installation and preventing obstructions to the updates due to long-period backwards compatibility requirements of services with complicated dependencies.

Finally, at block 1022, the fully configured Butterfly region can be placed under the control of the customer for use as a provider of cloud services within the destination data center environment.

FIG. 11 is a block diagram illustrating an example architecture 1100 for imaging server devices 1110-830 of a scalable footprint data center (e.g., Butterfly region 904 of FIG. 9), according to some embodiments. The architecture can include replicator service 1104, which may be an example of replicator service 922 of FIG. 9, as well as an image store 1106, which may be an example of image store 924 of FIG. 9.

A hyperconverged rack 1102 of the Butterfly region can include a BIOS device and server device 1110-1130. Although hyperconverged rack 1102 only depicts three server devices, exemplary hyperconverged racks can include more or fewer server devices, including up to 12 server devices in some examples. The BIOS device can also host a reconfiguration service (not pictured) which can orchestrate reconfiguration operations in conjunction with the image capture and replication operations performed with the replicator service 1104.

Each server device of the hyperconverged rack 1102 can include an ILOM and a storage device. For example, server device 1110 can include ILOM 1112 and storage device 1114, server device 1120 can include ILOM 1122 and storage device 1124, and server device 1130 can include ILOM 1132 and storage device 1134. As described above, an ILOM can be a processor or processing platform integrated with the server devices that can provide functionality for managing and monitoring the server devices remotely. The ILOM can be reachable via a communication connection separate from a typical network connection for the server devices (e.g., a fiberoptic Ethernet connection). The ILOMs can allow for configuration of the boot sequence of its corresponding server device, as well as configuring a boot volume or boot image for use by the server device when it starts.

The storage device for each server device in hyperconverged rack 1102 can represent one or more physical storage drives for the persistent data stored by the server device. For example, storage device 1114 of server device 1110 can represent the 14 NVMe disk drives of a hyperconverged server device. When an image of the server device is created, the data on the corresponding storage device can be copied to the image store 1106. When an image is to be deployed to a server device, the image can be retrieved from the image store 1106 and copied to the storage device.

To create an image and/or deploy an image, the replicator service 1104 can connect to each server device via the corresponding ILOM to configure a boot of the server device using a live-image. The live-image can contain an operating system and image creation and replication software that can perform the image creation and deployment operations. The replicator service 1104 may be hosted within an environment separate from the Butterfly region that includes hyperconverged rack 1102. For example, replicator service 1104 can be a cloud service provided by a CSP in a host region as part of one or more prefab services (e.g., prefab services 916 of FIG. 9).

The replicator service 1104 can receive a configuration file that identifies all of the server devices in hyperconverged rack 1102 and a path over which the replicator service 1104 can communicate with the corresponding ILOMs. The configuration file can also include information identifying a particular image and/or image set to use for deploying to the server device. The configuration file can also identify the image store 1106 to allow for network connection from the server devices 1110-830 to image store 1106. The replicator service 1104 can then connect to the server device 1110-830 via ILOMs 1112-832 and configure the server devices to boot from a live-image. The live-image can be stored in the dynamic memory of the server device so that the storage devices are not being used by the server device 1110 as boot volumes or other volumes that might change the data on the storage devices.

Once the live-image operating system is running, the included image creation and replication software can execute on the server devices to either create a new image and store it in image store 1106 or retrieve an image from image store 1106 and copy it to the corresponding storage device. The image creation and replication software can use the information of the configuration file from the replicator service 1104 to identify the created images with the device (e.g., the rack and server) from which the image was created. For example, each image can be identified with a rack number (e.g., hyperconverged rack 1) and a server device number (e.g., third server on the rack). Then, the image set can be referenced to identical hardware when replicating the images in the prefab factory.

A reconfiguration service on the BIOS device of the hyperconverged rack 1102 can monitor the server devices 1110-1130 for progress of the image creation or replication process until complete.

FIG. 12 is a block diagram illustrating an example architecture 1200 for reconfiguring services in a scalable footprint data center, according to some embodiments. The scalable footprint data center can include Butterfly region 1202, which may be an example of Butterfly region 904 described above with respect to FIG. 9.

The Butterfly region 1202 can include BIOS device(s) 1204 that is configured to host a reconfiguration service 1206. The reconfiguration service 1206 may be an example of other reconfiguration services described herein, including reconfiguration service 920 of FIG. 9. The Butterfly region 1202 can also include a plurality of services that are hosted on devices in the Butterfly region 1202, for example VMs on one or more server devices of the Butterfly region 1202 (or containers running on the VMs of the server devices). As depicted in FIG. 12, the services can include service 1 1208, service 2 1210, and additional services 1212. The services within Butterfly region 1202 may include one or more processes or applications for performing functionality within the Butterfly region 1202 and may be reachable via a network of the Butterfly region 1202, for example by exposing an accessible endpoint of an API for the service. In some embodiments, the services that are reconfigured as described herein may be hosted by the BIOS device(s) 1204 of the Butterfly region 1202. For example, a domain name system (DNS) service may be hosted on the BIOS device 1204 of the Butterfly region 1202. During a reconfiguration process, the DNS service can be reconfigured to modify or update the zones of the DNS namespace to adapt the networking environment of the Butterfly region 1202 for a customer network environment. The reconfiguration process can therefore include reconfiguration of a service hosted on the BIOS device(s) 1204 as well as the server devices of the Butterfly region 1202.

As described briefly above with respect to FIG. 9, the reconfiguration service 1206 can orchestrate a reconfiguration process for the services 1208-1212 within the Butterfly region 1202. The reconfiguration process can include multiple reconfiguration operations that are performed on a per-service basis, with each reconfiguration operation representing a modification or update to the configuration of a particular service and the entire reconfiguration process divided into one or more stages defined by the reconfiguration service 1206. The reconfiguration service 1206 can orchestrate the reconfiguration process by managing the status of the stages and providing the state information to the services. The services 1208-1212 can poll the reconfiguration service 1206 at a predetermined rate to check whether a stage of the reconfiguration process has started, triggering the services 1208-1212 to perform a corresponding reconfiguration operation, if any. Configuration information (e.g., new or updated configurations for software resources of the services) can be provided by an orchestration service 1214, which may be an example of orchestration service 918. The orchestration service 1214 can be a cloud service configured to deploy artifacts, including configuration information for services, to the provisioned infrastructure (e.g., server devices, VMs, etc.) to modify or update services or other deployed software within the Butterfly region 1202.

Once a service receives the status of the reconfiguration stage from the reconfiguration service 1206, the service can request reconfiguration status from other services in the Butterfly region 1202 before performing a corresponding reconfiguration process. For example, service 1 1208 can receive an indication from reconfiguration service 1206 that a current stage of the reconfiguration process has been initiated. The service 1 1208 can then query service 2 1210 and additional service(s) 1212 in the Butterfly region 1202 for the status of those services' reconfiguration. In this way, service 1 1208 can perform a reconfiguration operation for a resource of service 1 1208 while accounting for dependencies of service 1 1208 on service 2 1210 and/or the additional service(s) 1212.

As a particular example, service 1 1208 can be a public key infrastructure (PKI) service that is configured to vend certificates within the Butterfly region 1202. Service 2 1210 can be a DNS service configured to manage domain names and domain name resolution for hosts within the Butterfly region 1202. During a reconfiguration process, the network of the Butterfly region 1202 can be modified to reflect a change in the domain for the hosts within the Butterfly region 1202, for instance when the Butterfly region 1202 is configured for the networking environment at a customer's facility. One stage of the reconfiguration process, in this example, can be the update of the domain used by hosts in the Butterfly region 1202, so that the DNS service (service 2 1210) can be reconfigured to manage the new domain names and the PKI service (service 1 1208) can be reconfigured to vend certificates that reflect the updated domain. Because the PKI service can depend on the DNS service, the PKI service, having received the status of the reconfiguration stage from the reconfiguration service 1206, can then query the DNS service. The DNS service separately can perform reconfiguration operations to adapt the domains, including creating new zones for the domain. While the DNS service performs its reconfiguration operations (e.g., creating new zone(s)), the DNS service can advertise the status of its progress (e.g., a substate of the reconfiguration stage) to the other services in the Butterfly region 1202, including the PKI service. The PKI service can continue querying the DNS service until the PKI service receives an indication that the DNS service has successfully completed its reconfiguration operation to create the new zone. The PKI service can then perform a reconfiguration operation to begin vending certificates for the new domain. The PKI service can likewise advertise the substate of its reconfiguration operation (e.g., refreshing certificates within Butterfly region 1202). Once the reconfiguration operation is complete, the PKI service can provide the status update both to other services that query the PKI service (e.g., the DNS service) and to the reconfiguration service 1206. The DNS service can then determine that the PKI service has completed the certificate refresh and proceed to delete the zone(s) corresponding to the old domain.

FIG. 13 is a block diagram illustrating an example process 1300 of a reconfiguration service 1302 orchestrating a reconfiguration process with a service 1304 in a scalable footprint data center, according to some embodiments. The process 1300 can include a portion of one stage of the reconfiguration process, for example, an on-site reconfiguration of a Butterfly region (e.g., Butterfly region 1202 of FIG. 12) at a destination data center facility or a pre-imaging reconfiguration of the Butterfly region prior to creating images of the server devices in the Butterfly region. The reconfiguration service 1302 can be an example of reconfiguration service 1206 of FIG. 12, while service 1304 can be an example of the services 1208-1212 of FIG. 12 or other services of a Butterfly region described herein.

The process 1300 can include operations performed by the reconfiguration service 1302 and operations performed by the service 1304. As described above, the reconfiguration service 1302 can orchestrate a reconfiguration process by tracking the stages of the reconfiguration process, updating the state of the stage to trigger reconfiguration operations for the services in the Butterfly region, and maintaining information about the status of the services as they are reported by the services. The values for the stage names, stage status, state, and other information maintained by the reconfiguration service 1302 can be defined as part of the API for the reconfiguration service 1302.

At block 1310, the reconfiguration service 1302 can create a reconfiguration stage. The reconfiguration stage can include a stage name, which can be a human readable string that identifies the stage of the reconfiguration process. For example, the reconfiguration stage can identify an “On-Site region and realm metadata” reconfiguration stage in which services are updated and configured for a new region and realm in the Butterfly region at a destination facility (e.g., customer site). When creating the reconfiguration stage, the reconfiguration service 1302 can also create the current stage state to “INACTIVE.” The reconfiguration service 1302 can also create a stage payload. The stage payload can be data defining the reconfiguration process, including, for example, plan data identifying the services to be reconfigured in the stage, the reconfiguration operations to performed in the stage, and other information usable by the services to perform the corresponding reconfiguration operations of the stage.

At block 1312, the reconfiguration service 1302 can update the current stage of the reconfiguration process to be the stage created at block 1310. At block 1314, the reconfiguration service 1302 can update the state of the current stage to be “ACTIVE,” thereby triggering the reconfiguration operations of the stage performed by the services in the Butterfly region.

The service 1304 can poll (e.g., request reconfiguration stage information) from the reconfiguration service 1302 at a predetermined polling rate (e.g., every second, every minute, etc.). Once the reconfiguration service 1302 updates the stage to “ACTIVE” at block 1314, the service 1304 can receive the state of the stage and begin performing the reconfiguration operation(s) for that service in the stage. For example, the service 1304 can be a DNS service in the reconfiguration stage for on-site region and realm metadata reconfiguration, so that the service 1304 can perform one or more reconfiguration operations for updating the region and realm. The service 1304 can obtain the payload for the current stage from the reconfiguration service 1302. The service 1304 can use the payload to determine the operations to perform for reconfiguration.

At block 1320, the service 1304 can create a service state and set the service state value to “ACCEPTED.” The service state can be provided to the reconfiguration service 1304. At block 1322, the service 1304 can update the service state to “IN_PROGRESS” and similarly provide the state to the reconfiguration service. As part of creating the service state, the service 1304 can identify a resource of the service 1304 that corresponds to the reconfiguration operation for the state. For example, a DNS service can determine that the zone configuration is the resource to be modified and/or updated as part of a reconfiguration operation to adapt the region network to a new region or realm. In some embodiments, the service 1304 can define sub-states for subsets of the reconfiguration operations performed by the service 1304 in the stage. For example, the sub-states for a DNS service in the on-site region/realm update stage can define sub-states for updating the domain name, creating a corresponding zone, and removing a previous zone corresponding to the previous domain name. The state of each sub-state of the reconfiguration process for the service 1304 can be maintained by the service 1304 and provided to the reconfiguration service 1302.

At block 1324, the service 1304 can query other services in the Butterfly region. In response to the queries, the service 1304 can receive state information from the other services. The state information can identify the state of the other services reconfiguration operations (e.g., whether successfully completed). If the service 1304 depends on one of the other services successfully completing its reconfiguration operations prior to the service 1304 performing a reconfiguration operation, the service 1304 can use the state information to determine whether to initiate the reconfiguration operation.

At block 1326, the service 1304 can the perform the reconfiguration operation to update a resource of the service. For example, the service 1304 can obtain configuration information from an orchestration service (e.g., orchestration service 1214) to update the resource.

At block 1328, the service 1304 can update the service state to “SUCCEEDED” if the reconfiguration operation completed successfully. If the reconfiguration operation was not successful, the service 1304 can update the service state to “FAILED.” The service 1304 can provide the updated service state to the reconfiguration service 1302. A “FAILED” service state can trigger remedial action from the reconfiguration service 1302, including initiating a manual reconfiguration process for the service 1304. Once the reconfiguration service 1302 receives a “SUCCESS” state from each service participating in the reconfiguration stage, the reconfiguration service 1302 can update the current stage state to “IN-ACTIVE.”

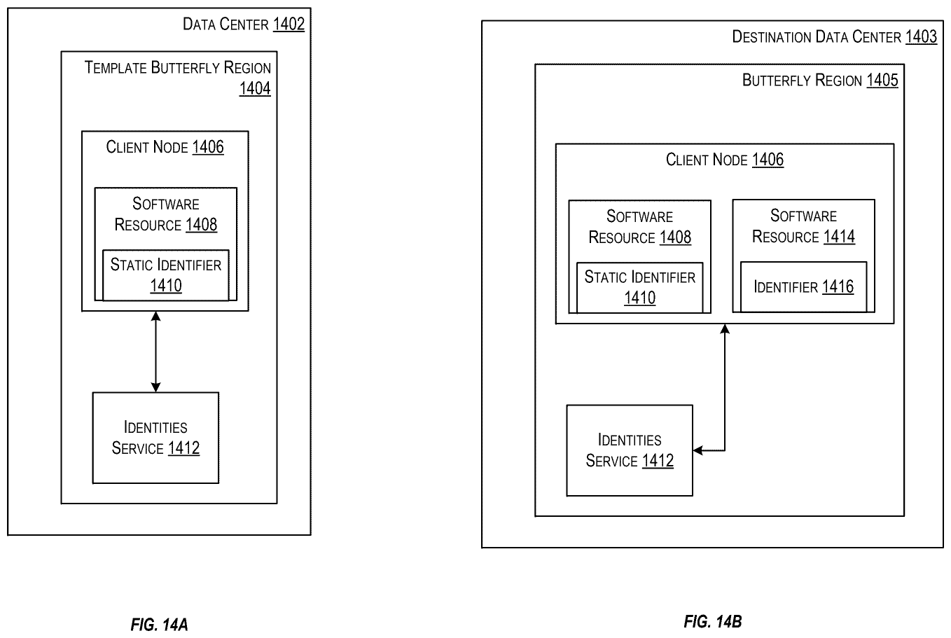

FIG. 14A is a block diagram illustrating an identities service 1412 configured to provide static identifiers (e.g., static identifier 1410) to resources (e.g., software resource 1408) during a region build operation, according to some embodiments. FIG. 14B is a block diagram illustrating the identities service providing identifiers to additional software resources in a scalable footprint data center environment after configuration at a destination data center facility, according to some embodiments. The region build operation can occur at a data center 1402, which may be a production data center or a facility like a prefab factory (e.g., prefab factory 902 of FIG. 9) in which the infrastructure and software for a region network (e.g., a Butterfly region 1404) can be provisioned and deployed to physical components (e.g., hyperconverged racks 906-910 of FIG. 9).

Software resources within a region network, including, for example, services, virtual machines, databases, object storage, compute instances, load balancers, as well as logical constructs like tenancies, can have unique identifiers assigned during region build operations. For example, the identifier can be a numeric identifier, a universally unique identifier (“UUID”), or other similar label that uniquely corresponds to the resource in the computing environment in which it executes. In some examples, the identifier can be a key in a database describing the records of the software resources in the computing environment. In addition to the unique identifier, software resources may also be associated with other identifiers, including human-readable labels like resource names. For example, the identifier may be constructed as a string including <TYPE>.<REALM>.<REGION>.<UUID>, where the fields in angle brackets can be labels for the associated data (e.g., a type of software resource like “VM” for virtual machine, a realm name, a region name, etc.) or a unique numeric or alphanumeric value (e.g., a UUID), which may be constructed by hashing the other components of the string and appended thereto or hashing other attributes and values associated with the resource. The hashing may be performed by any suitable algorithm for producing a hash value (e.g., cryptographic hash algorithms like SHA, message digest algorithms like MD5, digital signature algorithms, etc.). An identities service 1412 can be configured to create, lookup, retrieve, and return the identifiers to a requesting node (e.g., client node 1406) in the template Butterfly region 1404. The configuration of the identities service 1412 can ensure that calls requesting an identifier are idempotent, so that a request for an identifier using a set of input parameters (e.g., attributes, namespace, human-readable label, etc.) returns the same identifier from a second request using the same set of input parameters.

As shown in FIG. 14A, the template Butterfly region 1404 can be built during region build operations at a data center 1402. During region build operations, infrastructure resources, including software resources, can be deployed to the template Butterfly region 1404. Software resource 1408 can be deployed to client node 1406. As an example, software resource 1408 can include an application or a portion of an application executing on a virtual machine as the client node 1406. As another example, software resource 1408 may be a load balancer providing traffic routing within the template Butterfly region 1404, with the load balancer implemented on the infrastructure of the client node 1406. These examples are non-limiting, and the software resource 1408 may be an example of a number of other resources deployed within the template Butterfly region 1404. During the region build operations, the software resource 1408 can be assigned a static identifier 1410. The static identifier 1410 may uniquely identify the software resource 1408 within the template Butterfly region 1404.

As described above, a template Butterfly region 1404 can be built to provide an image set for subsequently replicating the image data to new hardware for deploying a Butterfly region 1405 at a destination data center 1403. When building the template Butterfly region 1404, the software resources deployed within the region network would typically be assigned an identifier according to the “region” and “realm” configurations of the data center 1402 in which the build operations were occurring. For example, the identities service 1412 within the region network can provide an identifier for each software resource deployed during the region build operations. Because the template Butterfly region 1404 is imaged to create the image set for replication to the physical components of the Butterfly region 1405 in a prefab factory, any identifiers generated in the template Butterfly region 1404 (e.g., persisted in caches, maintained in a database by the identities service 1412) will be the same for a Butterfly region 1405 built using the image set. Since the Butterfly region 1405 is installed at a destination data center 1403, which has its own “region” and “realm” labels, typical identifiers generated in the template Butterfly region 1404 would incorrectly reference the realm and region of the template Butterfly region 1404, impacting the ability of services in the Butterfly region 1405 to accurately resolve network endpoints for the corresponding software resources, which can impair network traffic within the Butterfly region 1405. For example, updated software deployments for a software resource can reference the software resource using its identifier, so that deploying updated configurations for the software resource can be impaired if the identifier does not accurately describe the realm and region of the software resource.

To avoid the above issues when performing prefab region build, the identities service can be configured to issue static identifiers (e.g., static identifier 1410). A static identifier can include <TYPE>.<REALM>.<REGION>.<UUID>, but rather than have a dynamic value for <REALM> and <REGION> (e.g., a value that corresponds to the particular realm and region of the template Butterfly region 1404), the static identifier 1410 can include a static string for these fields. For example, the realm field can be the string “<REALM>,” while the region field can be the string “<REGION>.” Then, a static identifier for software resource 1408 that is a block storage volume can be “ocid1.volume. <realm>.<region>. abuxgljr614nepxjkmbtnibwqpu5z24xdvmr7okzoi47wicoflrxh32rwd7a.” The static identifier 1410 can be used to accurately identify the resource within both the template Butterfly region 1404 (during pre-imaging reconfiguration operations) and the Butterfly region 1405 (during post-replication reconfiguration operations at the prefab factory or after installation of the Butterfly region 1405 at the destination data center 1403). To do this, any service or process parsing a request containing the static identifier 1410 can determine that the static string is present for one or both of the realm or region. Once the service determines that the static string is present in the static identifier, the service can take further action to determine the realm and region from the service's local context. For example, the service can obtain the region and realm information from a cache or from a local metadata management service within the template Butterfly region 1404 or Butterfly region 1405.

As depicted in FIG. 14B, a Butterfly region 1405 can be installed at a destination data center 1403 (e.g., a customer data center facility). The Butterfly region 1405 can be built using device images that were created from the template Butterfly region 1404. The Butterfly region 1405 can therefore include the software resource 1408 with its static identifier 1410. The Butterfly region 1405 can be part of a different region and realm as template Butterfly region 1404. As described briefly above, regions may be included in a realm. A realm can be a logical collection of regions, such that user tenancies can be assigned to realms and have access to tenancy data and resources within the realm in various regions and the associated data centers. The realm can be an attribute used to identify a resource within a region network of the realm. After on-site reconfiguration of the Butterfly region 1405, the identities service 1412 can begin providing identifiers that include dynamic values for region and realm that identify the corresponding region and realm for the Butterfly region 1405. The identities service 1412 can then stop providing static identifiers. For example, a new software resource 1414 can be deployed in the Butterfly region 1405 after on-site reconfiguration. The identities service 1412 can provide an identifier 1416 to the software resource 1414. The identifier 1416 can be used as a typical identifier in the Butterfly region 1405, in which services receiving the identifier 1416 can determine the region and realm information from the identifier 1416 itself.

In some embodiments, static identifiers like static identifier 1410 may only be provided to software resources in the template Butterfly region 1404 or the Butterfly region 1405 prior to an on-site reconfiguration process. After on-site reconfiguration, the identities service 1412 can be configured to only provide identifiers like identifier 1416 that include the region and realm information. In this way, static identifiers may only be available to the core services and associated software resources and not to customer software resources created in the Butterfly region 1405.

FIG. 15 is a flow diagram of an example process 1500 for imaging server devices of a scalable footprint data center, according to some embodiments. The process 1500 may be performed by one or more components of a computer system, including one or more components of a computer system in a prefab factory (e.g., Butterfly region 904) that are communicatively connected to a host region (e.g., host region data center). The operations of process 1500 may be performed in any suitable order, and process 1500 may include more or fewer operations than those depicted in FIG. 15.

The process 1500 can begin with a host device of a host region data center executing a region replicator, at block 1502. The region replicator can be an example of replicator service 922 of FIG. 9 or replicator service 1104 of FIG. 11. The region replicator can include one or more processes, applications, or other software configured to perform the operations described herein. The region replicator can expose an application programming interface (API) that is reachable by devices, services, applications, and other processes within the host region data center and a scalable footprint data center being built at a prefab factor. The host region data center can be communicatively connected to a plurality of computing devices of a scalable footprint data center. For example, a Butterfly region including the plurality of computing devices can be connected via a network (e.g., a public network connection) with the host region data center.

At block 1504, the region replicator can obtain configuration information for the plurality of computing devices for the scalable footprint data center. The configuration information can include connection information for a management controller of a computing device of the plurality of computing devices. The management controller can allow for the management of the computing device via commands or other information transmitted to the management controller. In some embodiments, the management controller can be an ILOM. In some embodiments, the connection information identifies a networking endpoint of the management controller.

At block 1506, the region replicator can configure the management controller to execute an imaging process on the computing device. For example, the region replicator can access a server device via an ILOM and configure the server device to boot using a live operating system image (e.g., a live-image). The live operating system image can include software instructions for the imaging process. The software instructions can include image creation and replication software. The management controller can be configured using the configuration information. The imaging process can be configured to perform an imaging operation for a storage device of the computing device. In some embodiments, the live operating system image can be maintained at the management controller during the boot sequence.

In some embodiments, the imaging operation is an image capture operation. The image capture operation can include generating an image of the storage device and storing the image at an image store communicatively connected to the plurality of computing devices of the scalable footprint data center. For example, a device image of the storage device can be created by copying the data on the storage device and storing that data in the image store.

In some embodiments, the imaging operation is an image replication operation. The image replication operation can include obtaining an image from the image store communicatively connected to the plurality of computing devices of the scalable footprint data center and replicating the image onto the storage device of the computing device. For example, the image creation and replication software can retrieve an image of an image set in the image store and copy the image to the storage device of the computing device.

At block 1508, the region replicator can receive an indication that the imaging operation is complete. For example, after the computing device boots using the live-image, the image creation and replication software can perform an imaging operation to replicate an image from an image set at an image store to the storage device of the computing device. After the image replication process is complete, the image creation and replication software can provide an indication to the region replicator that the replication process has completed successfully.

In some embodiments, the plurality of computing devices of the scalable footprint data center have been previously configured with software resources of one or more services configured to execute in the scalable footprint data center. For example, the plurality of computing devices can be the server devices of a template Butterfly region that is built and configured for use to create images for an image set.

In some embodiments, prior to obtaining the configuration information, the region replicator can receive an initial indication that a reconfiguration operation was performed for the plurality of computing devices of the scalable footprint data center. Responsive to that indication, the region replicator can obtain the configuration information and configure the management controller. For example, the imaging of a Butterfly region in a prefab factory can be orchestrated by a reconfiguration service that maintains the status of various stages and sub-stages of the process. The region replicator can query the reconfiguration service and receive information about the current stage of the build process. If the current stage indicates that the imaging process can proceed, the region replicator can perform the operations of the process 1500.

In some embodiments, the indication that the imaging process is complete can be used to initiate a reconfiguration operation for the plurality of computing devices of the scalable footprint data center. The reconfiguration operation can include an update to software resources of one or more services configured to execute in the scalable footprint data center.

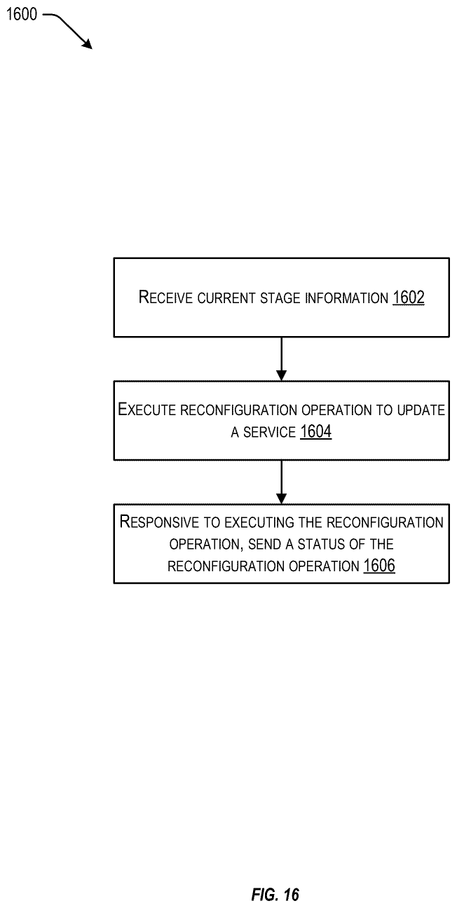

FIG. 16 is a flow diagram of an example process 1600 for reconfiguring a service in a scalable footprint data center, according to some embodiments. The process 1600 may be performed by one or more components of a computer system, including one or more components of a computer system in a prefab factory or at a destination data center environment (e.g., Butterfly region 904). The operations of process 1600 may be performed in any suitable order, and process 1600 may include more or fewer operations than those depicted in FIG. 16.

The process 1600 can begin with a service executing on a computing device of a scalable footprint data center receives current stage information for a reconfiguration process of services in the scalable footprint data center, at block 1602. The current stage information can be received from a reconfiguration service in the scalable footprint data center. The scalable footprint data center can include a Butterfly region (e.g., Butterfly region 1202 of FIG. 12). The current stage information can include a status of the reconfiguration process. For example, the current stage information can identify a current stage name and a status of “ACTIVE” identifying that the stage is currently being performed. The current stage information can be received in response to a query or request sent to the reconfiguration service from the service. For example, the service can poll the reconfiguration service at a predefined polling rate to check for the change of the status of the current stage to initiate the reconfiguration process for the service. The requests and the received data can be in the format of HTTP requests transmitted from the service to the reconfiguration service. In some embodiments, the reconfiguration service can execute on an initialization device of the scalable footprint data center (e.g., a BIOS device). In some embodiments, the reconfiguration process can include a pre-imaging reconfiguration of the scalable footprint data center. In some embodiments, the reconfiguration process comprises an on-site reconfiguration of the scalable footprint data center.

At block 1604, the service can execute a reconfiguration operation of the reconfiguration process to update a service resource of the service. The service can execute the reconfiguration operation based on the current stage information. For example, the current stage information can include the ACTIVE status which the service can use to initiate the reconfiguration operation.

At block 1606, the service can send a status of the reconfiguration operation to the reconfiguration operation. The status can be sent in response to beginning the reconfiguration operation. For example, the status can indicate that the reconfiguration operation is “IN_PROGRESS” by the service.

In some embodiments, executing the reconfiguration operation can include receiving the configuration information from an orchestration service. The configuration information can characterize a new state of the service resource. For example, the service resource can be a component of the service to be updated as part of the reconfiguration process. The configuration information can include the data to update the component. The service can then modify the service resource in accordance with the configuration information.

In some embodiments, the service can be a first service. The first service can query a second service executing in the scalable footprint data center. The query can request a current status of a second reconfiguration operation for the second service. The query can be sent in response to receiving the current stage information. The first service can then determine whether the current status of the second reconfiguration operation is complete. If the second reconfiguration operation is complete, the first service can execute the reconfiguration operation to update the service resource. For example, the first service may be a PKI service that depends on a DNS service (the second service) having completed the creation of a new zone corresponding to a new domain of the scalable footprint data center. Once the PKI service receives a current status from the DNS service that indicates that the new zone has been created, the PKI service can perform the reconfiguration operation to vend certificates corresponding to the new domain.

In some embodiments, prior to executing the reconfiguration operation, the service can send reconfiguration information to the reconfiguration service. The reconfiguration information can identify the service resource and indicate that the service will execute the reconfiguration operation.

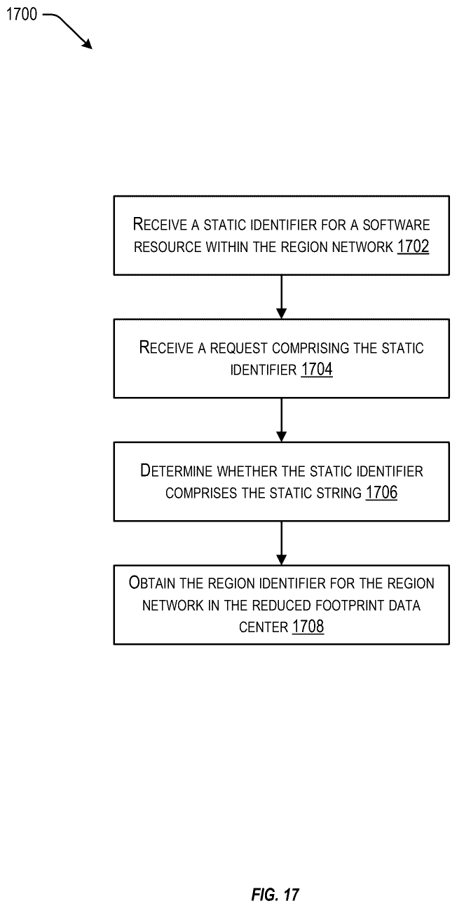

FIG. 17 is a flow diagram of an example process 1700 for providing static resource identifiers in scalable footprint data center, according to some embodiments. The process 1700 may be performed by one or more components of a computer system, including one or more components of a computer system built in a prefab factory and installed at a destination data center. The operations of process 1700 may be performed in any suitable order, and process 1700 may include more or fewer operations than those depicted in FIG. 17.

Process 1700 can begin at block 1702, with a computing node (e.g., client node 1406) receiving a static identifier for a software resource within a region network (e.g., template Butterfly region 1404). The static identifier can be received at a computing node in the region network. The static identifier can include a static string corresponding to a region identifier for the region network. For example, the static identifier can include a string “<REGION>” for the region, rather than data describing the current region. In some embodiments, the static identifier is generated by an identities service (e.g., identities service 1412 of FIG. 14A) in the region network.

At block 1704, a service executing in the region network can receive a request that includes the static identifier. The request can be received after the region network is configured in a scalable footprint data center. For example, the region network can be installed a customer data center facility and have on-site reconfiguration performed for the resources in the region network.

At block 1706, the service can determine whether the static identifier includes the static string. For example, the request can be a request for the service to perform an operation with respect to the software resource. The service can parse the static identifier and determine that at least one field (e.g., realm, region) includes the static string.

At block 1708, the service can obtain the region identifier from a datastore. The service can obtain the region identifier based on determining that the static string is present in the static identifier. The region identifier can correspond to the region network in the scalable footprint data center. For example, the service can obtain local metadata from a cache to determine the region for the software resource. In some embodiments, the service can obtain the region identifier from a datastore managed by a metadata management service within the region network. In some embodiments, the static string is different from the region identifier. For example, the static string may be the string “<REGION>,” while the region identifier may be a string “us-example-1” that identifies a specific region called us-example-1.

In some embodiments, receiving the static identifier can include receiving the static identifier during the region build process at a first data center facility. For example, an identities service (e.g., identities service 1412) can provide the static identifier for the software and wherein the software resource deployed to the region network maintains the static identifier after the region network is configured in the scalable footprint data center.

In some embodiments, after the on-site reconfiguration, the computing node can receive a resource identifier for an additional software resource in the region network. The resource identifier can include the region identifier. For example, new software resources can be deployed into the region network after it has been configured for the destination data center environment. The identities service can provide regular identifiers for these new resources.

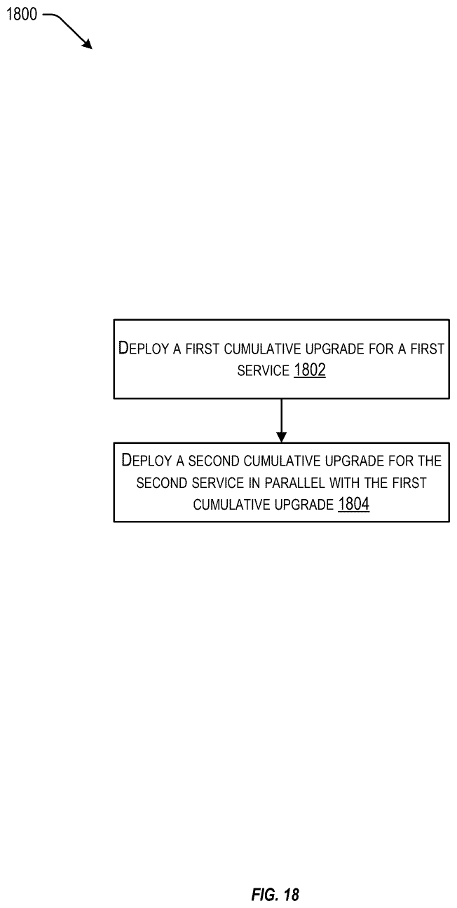

FIG. 18 is a block diagram illustrating an example process 1800 for deploying cumulative upgrades to services of a scalable footprint data center, according to some embodiments. The process 1800 may be performed by one or more components of a computer system, including one or more components of a computer system in a prefab factory or at a destination data center environment (e.g., Butterfly region 904). The operations of process 1800 may be performed in any suitable order, and process 1800 may include more or fewer operations than those depicted in FIG. 18.

As described above with respect to FIG. 10, service updates can include cumulative updates or upgrades that correspond to a relatively infrequent breakpoint, for example every calendar quarter or every six months. The breakpoint can be a time boundary that separates a first time period (e.g., quarter 1) from a second time period (e.g., quarter 2). Each service deployed to a Butterfly region can be configured to maintain compatibility within time periods separated by a time boundary. For example, a service can be configured to maintain compatibility for all of quarter 1 (e.g., January through March) of the calendar year, so that any updates to the service for the quarter do not impair the functionality of the service with respect to other services that interact with the service. For instance, during quarter 1, the service can receive an update to a software resource, such that another service that uses the service will obtain requested data or receive the expected function of the service regardless of whether the service includes the software resource or the updated software resource. In this way, services that have dependencies on other services can be updated with a cumulative upgrade for a time period, and all of the dependency services can also receive corresponding cumulative upgrades for the same time period. Because compatibility is maintained, the cumulative upgrade for one service can be deployed in parallel with the cumulative upgrade for a second service, even if the second service depends on the first service. The parallel deployment can greatly increase the speed at which services deployed from an image set (which may be out of date by the time replication occurs) are updated to the most recent versions in the scalable footprint data center.

The process 1800 can begin at block 1802, with deploying a first cumulative upgrade to a first service executing on a computing device for a scalable footprint data center. The first cumulative upgrade can include a first update to a software resource of the first service. The first update to the software resource producing an updated software resource. For example, the software resource can include a change to an application programming interface (API) of the first service, so that an existing API is deprecated and a new API is provided for use by other services in the scalable footprint data center environment. To maintain compatibility, the cumulative upgrade may not remove the deprecated API, but instead both APIs may be accessible for the first service. In some embodiments, deploying the first cumulative upgrade to the first service can occur in a prefab data center (e.g., prefab factory). In some embodiments, deploying the first cumulative upgrade to the first service can occur in the scalable footprint data center (e.g., after the region is built at a destination site).

At block 1804, a second cumulative update can be deployed to a second service executing on another computing device for the scalable footprint data center. The second service can have a dependency on the first service. For example, the second service may require the first service to perform functions (e.g., create or modify data, provide data to the second service, etc.) in order for the second service to handle requests. In some embodiments, the dependency of the second service on the first service includes a dependency on the software resource or the updated software resource. For example, the second service can depend on the first service having either the first software resource (e.g., a deprecated API) or the updated software resource (e.g., a new API), so that the first service maintains compatibility with either state of its upgrade. The second cumulative upgrade can be deployed in parallel with the first cumulative upgrade. In some embodiments, deploying the second cumulative upgrade to the second service can occur in a prefab data center (e.g., prefab factory). In some embodiments, deploying the second cumulative upgrade to the second service can occur in the scalable footprint data center (e.g., after the region is built at a destination site).

In some embodiments, the first cumulative upgrade and the second cumulative upgrade can be associated with a time boundary. The time boundary can characterize a time period of compatibility for the first cumulative upgrade to the first service and the second cumulative upgrade to the second service. For example, the first cumulative upgrade and the second cumulative upgrade can include all of the updates to the respective services that have been released in a time period before a calendar quarter boundary. The first cumulative upgrade and the second cumulative upgrade will then be quarterly cumulative upgrades to their respective services.

In some embodiments, the first cumulative upgrade is associated with a first time period before a time boundary. For example, the first cumulative upgrade can be a quarterly upgrade for a calendar quarter. The process 1800 can further include deploying an additional cumulative upgrade to the first service, the additional cumulative upgrade associated with a second time period after the time boundary. For example, the additional cumulative upgrade can be a quarterly upgrade for a second calendar quarter. The additional cumulative upgrade can include removing an API of the first service that was deprecated in the first cumulative upgrade for the first time period. For example, if the first quarterly upgrade included deprecating an API, the first quarterly upgrade for the first service can provide compatibility for both the deprecated API and a new API. The deprecated API can then be removed from the service with the second cumulative upgrade.

In some embodiments, the first cumulative upgrade and the second cumulative upgrade can be deployed to the first service and the second service by an orchestration service (e.g., orchestration service 1214 of FIG. 12).

### Example Computer System Architecture

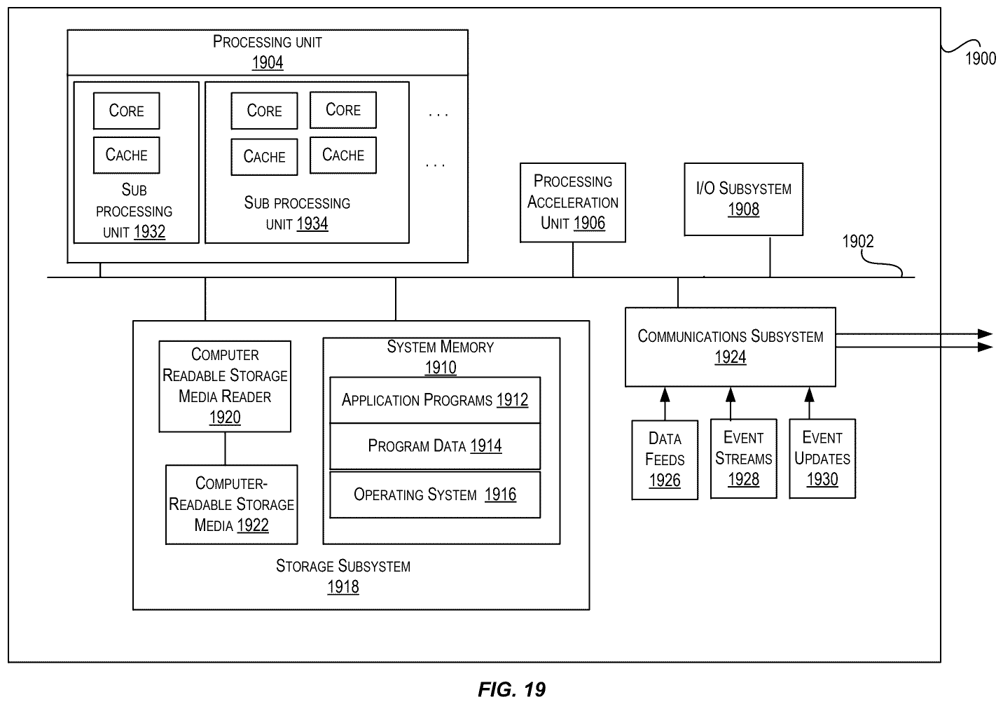

FIG. 19 illustrates an example computer system 1900, in which various embodiments may be implemented. The system 1900 may be used to implement any of the computer systems described above. As shown in the figure, computer system 1900 includes a processing unit 1904 that communicates with a number of peripheral subsystems via a bus subsystem 1902. These peripheral subsystems may include a processing acceleration unit 1906, an I/O subsystem 1908, a storage subsystem 1918 and a communications subsystem 1924. Storage subsystem 1918 includes tangible computer-readable storage media 1922 and a system memory 1910.

Bus subsystem 1902 provides a mechanism for letting the various components and subsystems of computer system 1900 communicate with each other as intended. Although bus subsystem 1902 is shown schematically as a single bus, alternative embodiments of the bus subsystem may utilize multiple buses. Bus subsystem 1902 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1904, which can be implemented as one or more integrated circuits (e.g., a conventional microprocessor or microcontroller), controls the operation of computer system 1900. One or more processors may be included in processing unit 1904. These processors may include single core or multicore processors. In certain embodiments, processing unit 1904 may be implemented as one or more independent processing units 1932 and/or 1934 with single or multicore processors included in each processing unit. In other embodiments, processing unit 1904 may also be implemented as a quad-core processing unit formed by integrating two dual-core processors into a single chip.

In various embodiments, processing unit 1904 can execute a variety of programs in response to program code and can maintain multiple concurrently executing programs or processes. At any given time, some or all of the program code to be executed can be resident in processor(s) 1904 and/or in storage subsystem 1918. Through suitable programming, processor(s) 1904 can provide various functionalities described above. Computer system 1900 may additionally include a processing acceleration unit 1906, which can include a digital signal processor (DSP), a special-purpose processor, and/or the like.

I/O subsystem 1908 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1900 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1900 may comprise a storage subsystem 1918 that provides a tangible non-transitory computer-readable storage medium for storing software and data constructs that provide the functionality of the embodiments described in this disclosure. The software can include programs, code, instructions, scripts, etc., that when executed by one or more cores or processors of processing unit 1904 provide the functionality described above. Storage subsystem 1918 may also provide a repository for storing data used in accordance with the present disclosure.

As depicted in the example in FIG. 19, storage subsystem 1918 can include various components including a system memory 1910, computer-readable storage media 1922, and a computer readable storage media reader 1920. System memory 1910 may store program instructions that are loadable and executable by processing unit 1904 as application programs 1912. System memory 1910 may also store data 1914 that is used during the execution of the instructions and/or data that is generated during the execution of the program instructions. Various different kinds of programs may be loaded into system memory 1910 including but not limited to client applications, Web browsers, mid-tier applications, relational database management systems (RDBMS), virtual machines, containers, etc.

System memory 1910 may also store an operating system 1916. Examples of operating system 1916 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems. In certain implementations where computer system 1900 executes one or more virtual machines, the virtual machines along with their guest operating systems (GOSs) may be loaded into system memory 1910 and executed by one or more processors or cores of processing unit 1904.

System memory 1910 can come in different configurations depending upon the type of computer system 1900. For example, system memory 1910 may be volatile memory (such as random access memory (RAM)) and/or non-volatile memory (such as read-only memory (ROM), flash memory, etc.) Different types of RAM configurations may be provided including a static random access memory (SRAM), a dynamic random access memory (DRAM), and others. In some implementations, system memory 1910 may include a basic input/output system (BIOS) containing basic routines that help to transfer information between elements within computer system 1900, such as during start-up.

Computer-readable storage media 1922 may represent remote, local, fixed, and/or removable storage devices plus storage media for temporarily and/or more permanently containing, storing, computer-readable information for use by computer system 1900 including instructions executable by processing unit 1904 of computer system 1900.

Computer-readable storage media 1922 can include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media.

By way of example, computer-readable storage media 1922 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1922 may include, but is not limited to, Zip® drives, flash memory cards, universal serial bus (USB) flash drives, secure digital (SD) cards, DVD disks, digital video tape, and the like. Computer-readable storage media 1922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program services, and other data for computer system 1900.

Machine-readable instructions executable by one or more processors or cores of processing unit 1904 may be stored on a non-transitory computer-readable storage medium. A non-transitory computer-readable storage medium can include physically tangible memory or storage devices that include volatile memory storage devices and/or non-volatile storage devices. Examples of non-transitory computer-readable storage medium include magnetic storage media (e.g., disk or tapes), optical storage media (e.g., DVDs, CDs), various types of RAM, ROM, or flash memory, hard drives, floppy drives, detachable memory drives (e.g., USB drives), or other type of storage device.

Communications subsystem 1924 provides an interface to other computer systems and networks. Communications subsystem 1924 serves as an interface for receiving data from and transmitting data to other systems from computer system 1900. For example, communications subsystem 1924 may enable computer system 1900 to connect to one or more devices via the Internet. In some embodiments communications subsystem 1924 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof)), global positioning system (GPS) receiver components, and/or other components. In some embodiments communications subsystem 1924 can provide wired network connectivity (e.g., Ethernet) in addition to or instead of a wireless interface.

In some embodiments, communications subsystem 1924 may also receive input communication in the form of structured and/or unstructured data feeds 1926, event streams 1928, event updates 1930, and the like on behalf of one or more users who may use computer system 1900.

By way of example, communications subsystem 1924 may be configured to receive data feeds 1926 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1924 may also be configured to receive data in the form of continuous data streams, which may include event streams 1928 of real-time events and/or event updates 1930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1924 may also be configured to output the structured and/or unstructured data feeds 1926, event streams 1928, event updates 1930, and the like to one or more databases that may be in communication with one or more streaming data source computers coupled to computer system 1900.

Computer system 1900 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1900 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, at a computing node in a region network and during a region build process, a static identifier for a software resource within the region network, the static identifier comprising a static string corresponding to a region identifier for the region network;
receiving, at a service executing in the region network and after the region network is configured in a scalable footprint data center, a request comprising the static identifier;
determining, by the service, whether the static identifier comprises the static string; and
based at least in part on a determination that the static identifier comprises the static string, obtaining, by the service from a datastore, the region identifier for the region network in the scalable footprint data center.

2. The method of claim 1, wherein receiving the static identifier comprises receiving the static identifier during the region build process at a first data center facility, and wherein the software resource deployed to the region network maintains the static identifier after the region network is configured in the scalable footprint data center.

3. The method of claim 1, wherein the static string is different from the region identifier.

4. The method of claim 1, further comprising receiving, at the computing node, a resource identifier for an additional software resource in the region network, the resource identifier comprising the region identifier.

5. The method of claim 1, wherein the static identifier is generated by an identities service in the region network.

6. The method of claim 1, wherein the datastore is a local metadata datastore managed by a metadata service.

7. The method of claim 1, wherein the datastore is a cache accessible to the service in the region network.

8. A computing system comprising:
one or more processors; and
one or more memories storing computer-executable instructions that, when executed by the one or more processors, cause the computing system to at least:
receive, at a computing node of the computing system and during a region build process, a static identifier for a software resource within a region network of the computing system, the static identifier comprising a static string corresponding to a region identifier for the region network;
receiving, at a service executing in the region network and after the region network is configured in a scalable footprint data center, a request comprising the static identifier;
determine, by the service, whether the static identifier comprises the static string; and
based at least in part on a determination that the static identifier comprises the static string, obtaining, by the service from a datastore, the region identifier for the region network in the scalable footprint data center.

9. The computing system of claim 8, wherein receiving the static identifier comprises receiving the static identifier during the region build process at a first data center facility, and wherein the software resource deployed to the region network maintains the static identifier after the region network is configured in the scalable footprint data center.

10. The computing system of claim 8, wherein the static string is different from the region identifier.

11. The computing system of claim 8, wherein the one or more memories store additional computer-executable instructions that, when executed by the one or more processors, cause the computing system to further receive, at the computing node, a resource identifier for an additional software resource in the region network, the resource identifier comprising the region identifier.

12. The computing system of claim 8, wherein the static identifier is generated by an identities service in the region network.

13. The computing system of claim 8, wherein the datastore is a local metadata datastore managed by a metadata service.

14. The computing system of claim 8, wherein the datastore is a cache accessible to the service in the region network.

15. A non-transitory computer-readable medium storing instructions that, when executed by one or more processors of a computing system, cause the computing system to at least:
receive, at a computing node of the computing system and during a region build process, a static identifier for a software resource within a region network of the computing system, the static identifier comprising a static string corresponding to a region identifier for the region network;
receiving, at a service executing in the region network and after the region network is configured in a scalable footprint data center, a request comprising the static identifier;
determine, by the service, whether the static identifier comprises the static string; and
based at least in part on a determination that the static identifier comprises the static string, obtaining, by the service from a datastore, the region identifier for the region network in the scalable footprint data center.

16. The non-transitory computer readable medium of claim 15, wherein receiving the static identifier comprises receiving the static identifier during the region build process at a first data center facility, and wherein the software resource deployed to the region network maintains the static identifier after the region network is configured in the scalable footprint data center.

17. The non-transitory computer readable medium of claim 15, wherein the static string is different from the region identifier.

18. The non-transitory computer readable medium of claim 15, wherein the one or more memories store additional computer-executable instructions that, when executed by the one or more processors, cause the computing system to further receive, at the computing node, a resource identifier for an additional software resource in the region network, the resource identifier comprising the region identifier.

19. The non-transitory computer readable medium of claim 15, wherein the static identifier is generated by an identities service in the region network.

20. The non-transitory computer readable medium of claim 15, wherein the datastore is a local metadata datastore managed by a metadata service.
